(19) United States
(12) Patent Application Publication
(10) Pub. No.: US 2026/0289430 A1
(43) Pub. Date: Sep. 24, 2026

(54) SYSTEM

(71) Applicant: SoftBank Group Corp., Tokyo (JP)

(72) Inventor: Aika KIYOUCHI, Tokyo (JP)

(73) Assignee: SoftBank Group Corp., Tokyo (JP)

(21) Appl. No.: 19/558,442

(22) Filed: Mar. 6, 2026

(30) Foreign Application Priority Data
Mar. 19, 2025 (JP) 2025-044511

(51) Int. Cl. G06Q 10/02; G06N 3/0464; G06N 3/0475; G06Q 30/0601; H04L 67/02

(52) U.S. Cl. CPC G06Q 10/02; G06N 3/0464; G06N 3/0475; G06Q 30/0619; H04L 67/02

(57) ABSTRACT

A system includes a processor that is configured to generate, by using a generative AI model, a prompt sentence based on a facility name input by a user, and cause, by using the prompt sentence, corresponding reservation information registered in one or more information sources to be listed, analyze, by using the generative AI model, advantages and disadvantages of the corresponding reservation information and compare the corresponding reservation information based on a result of the analysis, and generate, based on reservation information selected by the user, a prompt sentence that instructs a purchase to be performed, and perform the purchase by using the prompt sentence.

### CROSS-REFERENCE TO RELATED APPLICATION

This application is based on and claims priority under 35 USC 119 from Japanese Patent Application No. 2025-044511 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional reservation aggregation systems typically retrieve reservation information from multiple information sources and present the retrieved information to a user in a list format. In many such systems, the processes for searching, collecting, and comparing reservation information are based on predefined rules or static programs. As a result, these systems often suffer from limitations in flexibility and intelligence, such as an inability to appropriately interpret ambiguous or varied user inputs, difficulty in dynamically adapting to changes in external information sources, and limited capability to present advantages and disadvantages of reservation options in a form that is readily understandable to the user. Furthermore, in such conventional systems, even when multiple reservation options are displayed, the task of comparing advantages and disadvantages of the options, such as price, available time slots, and cancellation policies, is left largely to the user. This increases the cognitive burden on the user and makes it difficult for the user to promptly select an optimal reservation option. In addition, the transition from the comparison phase to the purchase phase is often implemented by simple linking or redirection, without intelligent support that takes into account the user's selection context.

Moreover, existing systems generally do not leverage generative AI models as a central mechanism for generating instructions, analyzing reservation information, and orchestrating the entire flow from information retrieval to purchase. Therefore, there is a need for a system that uses a generative AI model to generate prompt sentences, to control retrieval and comparison of reservation information, and to guide purchase processing in a unified and intelligent manner, thereby reducing the user's effort and improving the overall usability and effectiveness of reservation operations.

Accordingly, an object of the present invention is to provide a system that uses a generative AI model to generate prompt sentences based on a facility name input by a user, that analyzes and compares advantages and disadvantages of corresponding reservation information, and that generates prompt sentences to perform a purchase based on reservation information selected by the user, thereby enabling an intuitive, flexible, and intelligent reservation experience.

### SUMMARY

In order to achieve the above object, according to at least one embodiment of the present invention, there is provided a system comprising a processor, wherein the processor is configured to generate, by using a generative AI model, a prompt sentence based on a facility name input by a user, and to cause, by using the prompt sentence, corresponding reservation information registered in one or more information sources to be listed. The processor is further configured to analyze, by using the generative AI model, advantages and disadvantages of the corresponding reservation information and to compare the corresponding reservation information based on a result of the analysis. The processor is also configured to generate, based on reservation information selected by the user, a prompt sentence that instructs a purchase to be performed, and to perform the purchase by using the prompt sentence.

In one aspect, the processor is configured to generate, by using the generative AI model, a prompt sentence that instructs corresponding reservation information to be obtained from a plurality of information sources, and to obtain the corresponding reservation information from the plurality of information sources by using the prompt sentence. By employing the generative AI model to generate such prompt sentences, the system can flexibly interact with heterogeneous information sources and adapt to changes in external interfaces and data formats, thereby improving robustness and extensibility of the information retrieval process. In another aspect, the processor is configured to generate, by using the generative AI model, a prompt sentence that instructs that a purchase is to be directly performed at an information source selected by the user, and to perform the purchase by using the prompt sentence. Through this configuration, the system can seamlessly transition from the phase of comparing reservation options to the phase of executing a purchase, while maintaining contextual consistency with the user's selection and preferences.

By integrating the generative AI model into the core processing flow for generating prompt sentences, analyzing reservation information, and controlling purchase operations, the system according to the present invention can intelligently support the user throughout the entire reservation process. As a result, the system can reduce the user's cognitive load, facilitate efficient selection of optimal reservation options, and provide an improved user experience compared to conventional systems.

The term “system” refers to an apparatus or a combination of one or more apparatuses including at least one processor and, optionally, one or more memories and communication interfaces, configured to execute the functions described in the claims. The term “processor” refers to a hardware component, such as a central processing unit (CPU), a graphics processing unit (GPU), a microcontroller, or any other information processing circuit, or a combination thereof, that executes instructions to perform one or more operations described in the claims.

The term “generative AI model” refers to a machine learning model, such as a large language model, transformer model, or other neural network model, that is trained to generate text or other content in response to input data or prompts, and that is used to generate prompt sentences, analyze reservation information, and support purchase processing as described in the claims.

The term “prompt sentence” refers to a text string or sequence of tokens that is provided as input to the generative AI model or to an external system, and that specifies, in natural language or a structured format, an instruction or query for obtaining, analyzing, comparing, or purchasing reservation information.

The term “facility name” refers to a name or identifier of a facility, such as a restaurant, hotel, store, event venue, or other reservable location or service, which is input by a user and used as a basis for searching and obtaining reservation information.

The term “reservation information” refers to information related to making a reservation for a facility or service, including, for example, availability, date and time slots, pricing, seat or room types, cancellation policies, and links or identifiers required to complete a reservation or purchase.

The term “information source” refers to any external or internal source from which reservation information can be obtained, including, for example, reservation websites, application programming interfaces (APIs), databases, or other online or offline data repositories.

The term “advantages and disadvantages” refers to characteristics of reservation information that are evaluated in relation to user needs or preferences, including, for example, benefits such as lower price or more convenient time slots, and drawbacks such as stricter cancellation policies or higher fees, and that are analyzed and compared by the generative AI model.

The term “purchase” refers to a process of completing a reservation or booking transaction, which may include confirming reservation details, entering user information or payment information, and finalizing the reservation at an information source or via a linked service. The term “user” refers to a human operator or customer who interacts with the system, inputs a facility name, reviews listed reservation information, selects a reservation option, and, optionally, completes a purchase based on the selected reservation information.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

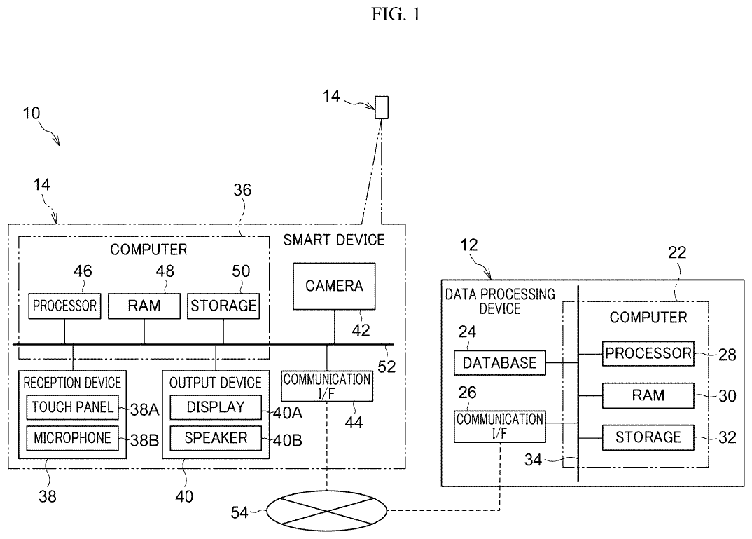

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

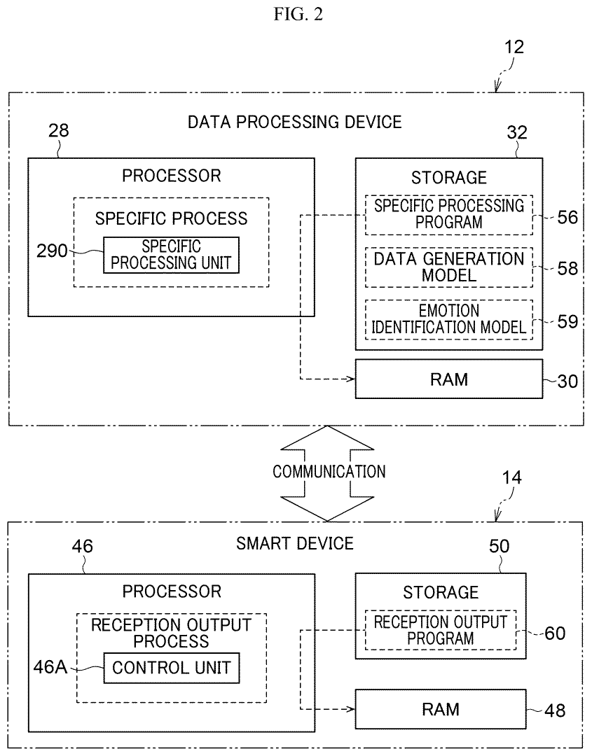

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional reservation aggregation systems typically rely on static application logic and fixed screen layouts to retrieve and present reservation information from multiple information sources. In such systems, a server generally executes predetermined scraping routines and displays the acquired reservation options in a table or list without dynamically adapting the retrieval, comparison, or guidance behavior to the user's intent expressed in natural language. As a result, the server is limited in its ability to flexibly tailor data acquisition, comparison criteria, and purchase guidance flows based on diverse and changing user requirements.

Moreover, in known architectures, scraping modules, data normalization components, and user interface generation components operate independently of any large-scale language understanding or reasoning capability. The server must embed complex comparison rules and decision logic directly in program code, which increases development and maintenance costs. When new comparison criteria, new types of reservation attributes, or new user preferences arise, the server-side software must be manually rewritten and redeployed. This rigid design leads to poor scalability and adaptability of the overall computer system.

In addition, existing systems frequently separate the data acquisition pipeline from any intelligent explanation or recommendation layer. Even if textual descriptions are generated, they are often simple templates that do not deeply analyze the advantages and disadvantages of each reservation option. Consequently, the user is forced to manually inspect and compare a large amount of structured and unstructured information displayed on a terminal, which increases cognitive load and processing time. The system itself does not efficiently leverage machine reasoning to guide users through selection and purchase steps.

Furthermore, when a user selects a reservation option and transitions to an external site for completing a purchase, conventional systems usually perform only a basic redirect without integrating higher-level guidance or validation. The server does not utilize generative models to generate step-by-step purchase instructions or to adapt guidance content to the specific attributes of the selected reservation information and the characteristics of the external information source. This can result in user confusion, incomplete purchases, or misalignment between the comparison page and the external purchase flow.

From a computer-technology standpoint, there is a need to improve the way a server coordinates scraping processes, data normalization, generative AI-based reasoning, and user interaction over networked devices. Specifically, there is a need for a server that can: (i) programmatically generate and send prompt sentences to a generative AI model in order to assist or control the behavior of the reservation retrieval and comparison pipeline; (ii) integrate the results of scraping and generative AI analysis into a unified data structure stored in a data repository; and (iii) provide adaptive, AI-generated guidance for selection and purchase that is consistently aligned with the underlying structured reservation data. Accordingly, an object of the present invention is to provide an improved computer system and server-side processing architecture that uses a generative AI model, controlled by dynamically generated prompt sentences, in combination with a scraping module, a data normalization module, and a guidance control module. This architecture is intended to reduce the computational complexity of hard-coded comparison logic, to improve the flexibility and extensibility of reservation information processing, to enhance the usability of the user interface on the terminal, and to enable more efficient and reliable completion of purchases on external sites.

The specific processing by the specific processing unit 290 of the data processing device 12 in Example 1 is realized by the following means.

The present invention provides a server comprising a processor configured to receive, from a user terminal via a communication interface, search conditions including a name specifying a facility, to generate a prompt sentence for a generative AI model in accordance with the search conditions, and to transmit a request including the prompt sentence to the generative AI model; the processor is further configured to execute, in a general-purpose program execution environment, a scraping program independently of a response from the generative AI model, to acquire reservation information from a plurality of information sources based on the search conditions, to normalize the reservation information by attribute including at least a price, an available time period, and a cancellation condition, to store the normalized reservation information in a data repository, and to generate display information for listing the reservation information to the user terminal based on the stored reservation information; the processor is further configured to generate, using attribute data of the stored reservation information, a comparison prompt sentence for the generative AI model, to transmit a request including the comparison prompt sentence to the generative AI model, to acquire from the generative AI model an analysis result indicating advantages and disadvantages for each piece of the reservation information, and to process the analysis result into a format associated with the list display and presentable to the user terminal; the processor is further configured to receive, from the user terminal, selection information indicating that one of a plurality of pieces of reservation information included in the list display has been selected, to identify, based on the selection information, connection destination identification information of an information source corresponding to the selected reservation information from the stored reservation information, and to generate control information for guiding the user terminal to an external site based on the connection destination identification information; and the processor is further configured to cause the generative AI model to generate a purchase instruction prompt sentence indicating that a purchase process based on the selected reservation information is to be executed at the external site, to acquire response data based on the purchase instruction prompt sentence, and to present, to the user terminal, guidance information regarding the purchase process based on the response data. This enables an integrated, computer-implemented reservation support system in which scraping-based data acquisition, attribute-level normalization, AI-based comparative analysis, and AI-driven purchase guidance are cooperatively executed under control of the processor, thereby improving the flexibility, maintainability, and usability of the server-side software architecture and reducing the processing burden on the user when retrieving, comparing, and purchasing reservation options across multiple information sources.

The term “system” refers to a combination of one or more computing devices including at least one processor, memory, communication interface, and associated software components that cooperate to execute the functions described in the claims.

The term “processor” refers to a hardware processing unit, such as a central processing unit or a processing core, or a plurality of such units, capable of executing machine-readable instructions to perform logical operations, arithmetic operations, control operations, and data processing operations.

The term “user terminal” refers to an electronic device operated by a user, such as a personal computer, a smartphone, a tablet, or any other network-enabled computing device, that includes a display, an input interface, and a communication interface for interacting with the system.

The term “communication interface” refers to a hardware and software interface, such as a network adapter, network stack, or communication module, configured to transmit data to and receive data from external devices or networks using wired or wireless communication protocols.

The term “search conditions” refers to one or more input parameters, provided by the user via the user terminal, that specify at least a name identifying a facility to be used and optionally include additional constraints such as date, time, price range, or other reservation-related preferences.

The term “facility” refers to a place, service, or resource that can be reserved or booked, including but not limited to restaurants, lodging facilities, event venues, transportation services, or activity providers.

The term “prompt sentence” refers to a machine-readable natural language or structured text string generated by the processor for submission to a generative AI model, the string describing a task, question, or instruction that directs the behavior of the generative AI model.

The term “generative AI model” refers to a machine learning model, such as a large language model, configured to generate text or other content based on an input prompt sentence and optionally contextual data, and capable of performing tasks including explanation, comparison, summarization, and guidance generation.

The term “request” refers to a data structure, message, or payload transmitted from the processor to the generative AI model, including at least a prompt sentence and optionally additional context, parameters, or metadata.

The term “response data” refers to output content returned by the generative AI model in reply to a request, including generated text that reflects interpretation of the prompt sentence and any associated input data.

The term “scraping program” refers to a software component or set of instructions executed in a general-purpose program execution environment to access network resources, retrieve content such as web pages or application responses, and extract reservation information from one or more information sources.

The term “general-purpose program execution environment” refers to a software runtime environment, such as an operating system and associated libraries or interpreters, capable of executing application programs not limited to a specific dedicated function, including but not limited to scripting languages, virtual machines, or native executables.

The term “information source” refers to any external data provider accessible over a communication network, such as a website, web application, database, or application programming interface, that provides reservation information related to facilities.

The term “reservation information” refers to structured or semi-structured data representing conditions and details of making a reservation for a facility, including at least a price, an available time period, and a cancellation condition, and optionally including additional attributes such as capacity, plan type, or special terms.

The term “price” refers to a monetary amount or range of amounts required to make or complete a reservation for a facility, including any associated fees, charges, or discounts when represented as data.

The term “available time period” refers to a representation of one or more time slots, date ranges, or periods during which a reservation for a facility can be made or used, expressed as time-related data.

The term “cancellation condition” refers to a rule, policy, or constraint that specifies whether, when, and under what financial or procedural terms a reservation may be canceled or modified, including penalties, deadlines, and refund rules.

The term “normalize” refers to processing heterogeneous reservation information from multiple information sources into a standardized internal representation by unifying formats, units, and structures of attributes such as price, time periods, and cancellation conditions. The term “store” refers to writing or maintaining data in a memory or persistent storage medium, such as a database, file system, or non-volatile storage device, in a manner that allows subsequent retrieval and processing.

The term “data repository” refers to a logical or physical storage component, such as a database system or data store, configured to hold normalized reservation information and associated metadata for later retrieval and processing.

The term “display information” refers to structured data or content generated by the processor that defines how reservation information and related analysis are to be presented on the user terminal, including layout, ordering, and association of items.

The term “list display” refers to a presentation format in which multiple pieces of reservation information are arranged as a list or table on the user terminal, enabling a user to view, compare, and select among the displayed reservation options.

The term “attribute data” refers to individual fields or properties of reservation information, such as numerical values, text descriptions, identifiers, or time stamps, that describe specific aspects of each reservation option.

The term “comparison prompt sentence” refers to a prompt sentence generated by the processor to instruct the generative AI model to analyze, compare, or evaluate reservation information based on attribute data and to output an analysis result indicating advantages and disadvantages.

The term “analysis result” refers to generated content obtained from the generative AI model, including descriptive or evaluative text that identifies advantages, disadvantages, trade-offs, or recommendations regarding one or more pieces of reservation information.

The term “selection information” refers to data received from the user terminal indicating that a particular piece of reservation information has been chosen by the user from among a plurality of displayed reservation options.

The term “connection destination identification information” refers to data, such as a uniform resource locator or other addressing information, that uniquely identifies an external information source or external site corresponding to a specific piece of reservation information.

The term “control information” refers to data generated by the processor for guiding or controlling the behavior of the user terminal, including data that causes the user terminal to transition to, or access, an external site associated with selected reservation information. The term “external site” refers to a network-accessible computing resource, such as a web service or application operated independently of the system, on which a reservation-related purchase process for a facility can be performed.

The term “purchase process” refers to a sequence of operations for completing a reservation transaction, including confirmation of reservation details, input of user information, execution of payment, and issuance of reservation confirmation.

The term “purchase instruction prompt sentence” refers to a prompt sentence generated by the processor to instruct the generative AI model to generate guidance or instructions relating to execution of a purchase process on an external site, based on selected reservation information.

The term “guidance information” refers to content presented to the user terminal, derived from the response data of the generative AI model, that explains, recommends, or guides steps for completing a reservation or purchase process on the external site.

In one embodiment, a server includes at least one processor, a main memory, a non-volatile storage device, and a communication interface connected to a network. The server executes an operating system such as a general-purpose server operating system and a web application framework such as a general-purpose web framework. The server also executes an application program written, for example, in a high-level programming language that coordinates a scraping module, a data normalization module, a reservation information repository, and an interface to a generative AI model.

The server uses a relational database management system such as a general-purpose SQL database to store normalized reservation information and associated metadata. The server uses a web server component and an application server component to receive HTTP or HTTPS requests from one or more terminals and to return dynamically generated HTML or other structured responses.

The terminal includes a processor, a memory, a display, an input interface such as a keyboard or touch panel, and a network interface. The terminal executes a web browser that can render HTML, execute client-side scripts, and exchange HTTP or HTTPS messages with the server. The user operates the terminal to input search conditions and to view, compare, and select reservation options.

The user inputs, via an HTML form displayed on the terminal, a facility name as a search condition, such as “Restaurant A” or “Hotel B”, and optionally an additional natural language prompt sentence for a generative AI model, such as “Compare the reservation options for Restaurant A and explain which option is best for a user who values free cancellation.” The terminal transmits these inputs to the server using HTTP or HTTPS.

The server receives the search condition and, in a first phase, generates a prompt sentence for a generative AI model. The server structures this prompt sentence in natural language so that it clearly defines a computational task, such as extraction of key attributes or comparison logic, in a way that a transformer-based neural network can process efficiently. For example, the server can generate a prompt sentence such as:
“Given a set of reservation options for a particular facility, each with price, available time periods, and cancellation conditions, describe the criteria that should be used to compare these options for a cost-conscious user who prefers flexible cancellation.”

The server transmits this prompt sentence and any necessary context to a generative AI model executing either on a separate computing system or as a service accessible over the network. The generative AI model is, in one embodiment, a transformer-based neural network with multiple encoder-decoder layers, self-attention heads, and position-wise feedforward networks. The generative AI model has been trained using supervised and unsupervised learning on large-scale text corpora, including domain-specific texts related to reservations, scheduling, and policies. During training, the model minimizes a loss function such as cross-entropy between predicted tokens and actual tokens, and uses gradient-based optimization such as stochastic gradient descent or an adaptive optimizer to update internal weight parameters. The model uses tokenization and embedding layers to convert input prompt sentences into numerical feature vectors, applies multi-head attention to compute contextual relationships between tokens, and generates output tokens representing textual analysis or instructions.

The server does not rely on the generative AI model to perform generic business decision making. Instead, the server uses the generative AI model as a computational component that transforms high-dimensional text inputs, including prompt sentences and attribute data, into structured comparative explanations and guidance instructions that are then integrated into the server's data structures and control logic. This integration reduces the amount of hand-coded rule logic and allows the server to dynamically adapt to different types of reservation attributes and comparison criteria without recompilation of application code.

The server, in parallel or independently of the generative AI model response, executes a scraping module on the same processor or on a worker process. The server uses a general-purpose HTTP client library to send requests to multiple reservation information sources and receives HTML or structured responses. The server uses a parsing library to extract elements such as price fields, time slot entries, and cancellation policy descriptions. If necessary, the server uses a browser automation engine to render dynamic content executed by client-side scripts and to capture the resulting DOM, from which reservation attributes are extracted.

The server normalizes the extracted reservation data into a unified internal schema. The server converts various price formats into a standardized numeric currency representation; the server parses localized date and time expressions into unified timestamp objects; and the server converts unstructured cancellation texts into normalized attributes, such as “free cancellation until X hours before” or “100% charge within Y hours”. The server stores these normalized attributes in records in the relational database, where each record includes fields such as a facility identifier, an information source identifier, a price field, a time period field, a cancellation condition field, and a URL field.

The server uses specific data structures designed to improve memory locality and query performance. For example, the server stores prices as fixed-width numeric columns, stores time periods as indexed ranges, and stores cancellation condition types as enumerated codes. By doing so, the server can perform queries and comparisons over large volumes of reservation data with reduced computational overhead and improved response times, which is a concrete improvement over systems that rely solely on textual or loosely structured data formats.

The server generates a comparison prompt sentence using the stored attribute data. In one example, the server constructs a textual summary of reservation options, such as: “Option 1: Source X, price 5000 JPY, available 18:00-20:00, free cancellation up to 24 hours before. Option 2: Source Y, price 5200 JPY, available 19:00-21:00, 50% charge if canceled within 24 hours. Option 3: Source Z, price 4800 JPY, available 17:00-19:00, no free cancellation.”

The server then appends an instruction element, such as:
“Compare these options. Explain the advantages and disadvantages of each option focusing on price, available time periods, and cancellation conditions for a user who wants to minimize cost but avoid high cancellation penalties.”

The server transmits this comparison prompt sentence, along with the structured attributes, to the generative AI model. The generative AI model, using its internal attention mechanisms and learned parameters, processes the prompt sentence to generate a textual analysis. The server receives this analysis and associates it with the corresponding records in the database or with a generated output structure. Because the model has been trained to interpret structured lists and to weigh multiple criteria, the server can obtain an analysis that goes beyond straightforward template filling and uses non-linear relationships between attributes. This yields more accurate and context-sensitive comparative information than fixed rule-based systems.

The server generates display information for the terminal using an HTML template engine. The server constructs, for example, a table where each row corresponds to a reservation option and columns represent price, available time period, cancellation condition, and a link or button for selection. The server inserts, in proximity to this table, the analysis text from the generative AI model, and optionally an additional text area where the user can enter a new prompt sentence such as:
“Explain only the options with free cancellation and recommend one option for a family with children.”

The terminal renders this display on the user's screen. The user reads the comparative explanations and selects one of the displayed reservation options by clicking a button or link. The terminal sends selection information, such as a reservation identifier, back to the server. The server identifies the corresponding record in the database using the reservation identifier and retrieves the URL of the external information source for the selected option. The server generates control information instructing the terminal to redirect to the external site, such as an HTTP redirect response. The terminal receives and executes this redirect, thereby loading the external site's reservation or payment page.

The server, in some embodiments, generates a purchase instruction prompt sentence that incorporates details of the selected reservation option and the external site characteristics. For example, the server can generate:
“Given that the user has selected a reservation option with price 5000 JPY, available at 19:00-21:00, and free cancellation up to 24 hours, provide step-by-step guidance for completing the reservation and payment on an external booking site, including which fields should be checked carefully and any warnings about cancellation penalties.”

The server sends this purchase instruction prompt sentence to the generative AI model, receives response data describing detailed guidance steps, and formats this guidance for display on the terminal either before redirection or in a separate help window. This allows the server to provide user-specific, context-aware guidance without manually coding a separate help script for each external site.

The generative AI model, in one embodiment, is further customized or fine-tuned using reservation-specific training data. The server collects historical reservation records, user preference logs, and known cancellation patterns. The server uses these data as training examples to fine-tune the generative AI model with a supervised learning procedure, minimizing an error function that measures deviation between model outputs and expert-written comparative analyses or guidance texts. The server applies regularization techniques and mini-batch training to update model weights while preventing overfitting.

The server, by using such fine-tuned models, improves the consistency and accuracy of AI-generated analyses, which in turn reduces misclassification of options and improves the reliability of purchase guidance. This improvement in model quality directly reduces the need for human oversight and lowers the computational cost of running complex rule-based engines, thereby providing a concrete improvement in the operation of the server as a computing platform.

The server also implements non-conventional processing rules that are specifically tailored to combining scraped data with generative AI results. For example, the server can assign priority scores to options by combining numeric measures (such as normalized price and time flexibility) with sentiment-like scores extracted from the generative AI output. The server can represent these scores as vectors and compute weighted sums or distances. By doing so, the server can sort or filter reservation options in a way that is not achievable by simple rule lists and that exploits high-dimensional representations computed by the neural network. This hybrid numeric-symbolic processing leads to faster convergence on an optimal or near-optimal option set under complex user preferences.

The server reduces network and computational load by caching normalized reservation data and AI analysis results. The server stores, for example, a hash of the input search condition and prompt sentences and uses this hash to detect repeated or similar queries. When a new request arrives that is substantially identical to a previous request, the server can reuse stored normalized data and analysis text instead of performing full scraping and inference again. This caching strategy decreases redundant interactions with external sites and generative AI services, reduces latency, and lowers communication load on the network.

The server improves data management by maintaining explicit relationships among facilities, information sources, reservation attributes, and AI analyses. The server uses foreign-key relationships and indexed columns in the database to support efficient joins and fast retrieval of relevant records. This structured data model enables the server to apply consistent AI-generated interpretations across different queries while maintaining referential integrity and traceability. Because the server can quickly locate and update only those records associated with specific changes in policies or prices, the system avoids full reprocessing of all reservation data, enhancing scalability.

The server achieves improved processing speed and accuracy in comparison and guidance because the generative AI model exploits learned internal representations and attention mechanisms that are not limited to simple rules based on local fields. For example, the model can infer that a slightly higher price with a more flexible cancellation window may be preferable under certain user-specified risk preferences, and can articulate this reasoning concisely. Such reasoning would require a large rule set and complex conditional logic in a conventional system, whereas in the disclosed system the neural network parameters encode this behavior through gradient-based learning. The result is a reduction in software complexity and an improvement in maintainability of the server application.

The terminal, as an active participant, provides interactive capability to the user. The terminal can display additional text input fields that allow the user to specify nuanced prompt sentences, such as:
“Prioritize options that minimize total cost including cancellation penalties and transportation time from my home address.”

In response to such prompt sentences, the server can extend the feature set by integrating additional data sources such as travel time estimations, and can modify its comparison prompt sentence accordingly. As a result, the system supports complex, personalized queries without requiring a separate user interface or engine for each new criterion, demonstrating a technical improvement in flexibility and modularity of the client-server architecture. The user benefits from reduced cognitive load because the server condenses large sets of heterogeneous reservation data and complex policies into concise, structured explanations, while maintaining direct mapping between AI-generated text and underlying normalized attributes. This tight coupling prevents inconsistencies between displayed explanations and stored data and ensures that any subsequent update to underlying attributes, such as a changed cancellation policy, can be propagated to AI prompts and outputs.

Alternative embodiments are possible. The server, instead of using a fully external generative AI service, can host the generative AI model locally on its own hardware, where specialized accelerators such as graphics processing units or tensor processing units perform matrix multiplications and attention operations. In another embodiment, the server uses a smaller, distilled version of the generative AI model for real-time inference, and defers more complex analysis to a larger model during off-peak hours. The server can switch between models based on latency constraints, resource availability, or user subscription level.

The server can also vary the scraping method. In one embodiment, the scraping module accesses application programming interfaces that directly return structured reservation data in a machine-readable format. In another embodiment, the scraping module uses headless browser automation only when a site uses heavy client-side rendering. The server may select an appropriate scraping strategy based on stored metadata about each information source, thereby optimizing resource usage.

The system can be adapted to different domains beyond facility reservation while maintaining the same technical framework. For example, the server can process inventory offers for physical products, service plans, or transportation tickets, by normalizing prices, availability, and return policies, and by using generative AI models to generate domain-specific comparative analyses and purchase guidance. In each case, the technical operation of the server—scraping, normalization, AI-aided comparison, and guided redirection—remains the same, and the improvements to data processing efficiency and user interaction carry over. By integrating a transformer-based generative AI model, prompt-sentence generation logic, structured scraping and normalization, and sophisticated data management on the server, the system produces a concrete technical effect: faster and more accurate handling of reservation data across multiple sources, reduced need for complex hard-coded logic, improved scalability with respect to new attributes and criteria, and lower communication and computational overhead through caching and structured processing. These characteristics demonstrate that the disclosed system is not limited to abstract idea processing or mere business method automation but instead provides a specific improvement to computer technology in the context of reservation information processing.

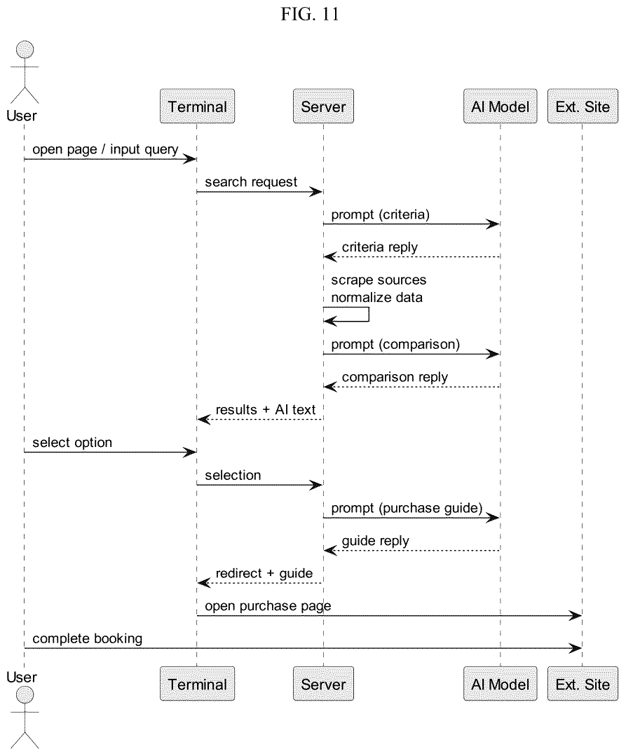

The following describes the processing flow using FIG. 11.

### Step 1:

User operates the terminal to open a reservation search page provided by the server and enters search conditions.

User inputs, via a form rendered on the terminal's browser, at least a facility name and optionally additional conditions such as desired date, time range, and number of persons, and may also input a prompt sentence for a generative AI model.
Input: raw text fields (facility name, optional date/time, optional AI prompt sentence).
Output: a completed form on the terminal ready for submission.

User triggers form submission, causing the terminal to package the inputs for transmission. Step 2:

Terminal transmits the search conditions and optional prompt sentence to the server. Terminal constructs an HTTP or HTTPS request containing the facility name and other search parameters, encodes them as query parameters or a request body, and includes any session identifiers or security tokens.
Input: user-entered search conditions and optional prompt sentence.
Output: a network request message sent to the server through the communication interface. Terminal then waits for a response while maintaining the user session state.

### Step 3:

Server receives the search request and validates and normalizes the input.

Server parses the incoming HTTP request, extracts the facility name and other search parameters, and checks them for validity (e.g., non-empty, allowed character set, length limits).
Input: raw request data containing search conditions and optional AI prompt sentence.
Output: a structured internal parameter object (e.g., facility identifier, normalized date/time range, user preferences, candidate prompt text).

Server trims whitespace, converts date/time to a standard internal format, and stores temporary context in memory for subsequent processing.

### Step 4:

Server generates a first prompt sentence for the generative AI model to determine comparison criteria or analysis strategy.

Server constructs a natural language prompt using the structured parameters, including the facility type and any user priorities (e.g., price-sensitive, cancellation-flexible), and may append default instructions if the user did not provide a prompt.
Input: structured parameter object (facility name, user preferences, optional user prompt sentence).
Output: a first AI prompt sentence that clearly specifies the analysis or comparison task for the generative AI model.

Server prepares a request payload for the generative AI model, embedding the prompt sentence and metadata such as language and expected output format.

### Step 5:

Server sends the first prompt sentence to the generative AI model and receives an analysis or guideline response.

Server invokes an AI inference API over the network or a local inference engine, transmits the prompt sentence as tokenized text, and waits for generated output from the model's decoder.
Input: first AI prompt sentence and optional context parameters.
Output: AI response text describing, for example, which attributes to compare (price, time, cancellation), how to weigh them, and any narrative style or structure to use in later explanations.

Server parses this response into a structured guideline representation, such as a set of comparison criteria and weight hints, and stores it in memory.

### Step 6:

Server executes a scraping program to acquire reservation information from multiple information sources.

Server uses an HTTP client and, if needed, a browser automation engine to access reservation pages or APIs of several sites, substituting the facility name and optional date in query parameters, downloads HTML or structured responses, and parses out price, available time periods, and cancellation conditions.
Input: structured parameter object (facility name, date/time, other constraints).
Output: a collection of raw reservation records from multiple information sources, each containing at least source identifier, price text, time slot text, and cancellation policy text.

Server aggregates these raw records into an in-memory list for normalization.

### Step 7:

Server normalizes and structures the scraped reservation data.

Server converts price strings into numeric values with standardized currency; parses date/time strings into timestamp objects; and transforms free-form cancellation texts into standardized attributes (e.g., free cancellation deadline, penalty percentages).
Input: raw reservation records from the scraping program.
Output: normalized reservation records in a unified internal schema, each record including facility identifier, source ID, numeric price, structured time periods, standardized cancellation condition, and original URL.

Server then writes these normalized records into a relational database, creating or updating rows in tables optimized for querying and comparison.

### Step 8:

Server generates a comparison prompt sentence that includes the normalized reservation attributes.

Server constructs a text summary of each reservation option (e.g., “Option 1: Source A, price X, time slots Y, cancellation Z”) and appends instructions based on the guideline from the first AI response, such as focusing on specific trade-offs.
Input: normalized reservation records and guideline representation from the first AI response.
Output: a detailed comparison prompt sentence that enumerates the options and instructs the generative AI model to produce an advantage/disadvantage analysis.

Server packages this comparison prompt into a second AI request payload.

### Step 9:

Server sends the comparison prompt sentence to the generative AI model and receives a comparative analysis.

Server transmits the second prompt sentence to the generative AI model via an API call, causing the model to process the listed options and generate explanatory text comparing them by price, time, and cancellation risk.
Input: second AI prompt sentence containing enumerated options and comparison instructions.
Output: AI response text containing per-option advantages and disadvantages and, optionally, a recommended option or ranking.

Server splits this response into sections mapped to specific reservation record identifiers and stores links between each record and its corresponding explanation snippet.

### Step 10:

Server generates a comparison page for the terminal using the normalized data and AI analysis.

Server queries the database for the normalized records associated with the current search, orders them using numeric criteria (e.g., ascending price or weighted scores), and passes both the records and AI explanation snippets to a template engine to create HTML.
Input: normalized reservation records for the search and associated AI-generated analysis text.
Output: an HTML document (or equivalent structured response) including a list or table of reservation options with columns for price, time, cancellation condition, and AI commentary, plus selection controls such as buttons or links.

Server sends this HTML document as an HTTP response to the terminal.

### Step 11:

Terminal renders the comparison page and accepts a reservation selection from the user. Terminal's browser parses the HTML, displays the list of reservation options and the AI-generated advantages and disadvantages, and activates interactive elements such as “Select this option” buttons.
Input: HTML page with structured reservation list and AI commentary.
Output: a visible, interactive user interface and an internal mapping from user interface elements to reservation identifiers.

User reviews the displayed options and AI explanations and then selects a desired option by activating a corresponding control.

### Step 12:

Terminal transmits selection information corresponding to the chosen reservation option to the server.

Terminal captures the reservation identifier and any associated attributes from the selected control, constructs a new HTTP or HTTPS request containing this identifier and session data, and sends the request to the server.
Input: user action indicating selection of a reservation option; reservation identifier embedded in the UI element.
Output: a selection request message transmitted to the server including the reservation identifier and user session information.

### Step 13:

Server resolves the selected reservation and identifies the external information source. Server parses the selection request, extracts the reservation identifier, and queries the database to retrieve the corresponding normalized record, including the connection destination identification information such as an external URL.
Input: selection request containing reservation identifier.
Output: a selected reservation record containing source identifier, destination URL, and relevant attributes (price, time, cancellation).

Server stores a record of the selection event, which can be used later for logging or analytics.

### Step 14:

Server optionally generates a purchase instruction prompt sentence tailored to the selected reservation and obtains guidance text from the generative AI model.

Server composes a prompt sentence describing the selected option's attributes (price, time, cancellation) and instructing the generative AI model to produce step-by-step guidance for completing the purchase on the identified external site.
Input: selected reservation record and any stored guideline or user preferences.
Output: a purchase instruction prompt sentence specifying the context and desired form of purchase guidance.

Server transmits this prompt to the generative AI model, receives a detailed guidance response, and formats the response for display as text instructions or hints on the terminal.

### Step 15:

Server generates control information for redirecting the terminal to the external site and, optionally, attaches purchase guidance information.

Server creates an HTTP redirect response that includes the external URL as the location target and may embed or reference the AI-generated purchase guidance in the response or in a separate resource.
Input: selected reservation record (including external URL) and AI-generated purchase guidance text.
Output: a response message that directs the terminal to the external site and, optionally, carries guidance information or a link to such guidance.

Server sends this response to the terminal through the communication interface.

### Step 16:

Terminal follows the redirect to the external site and presents any guidance information to the user.

Terminal's browser automatically issues a new request to the external URL received in the redirect response and loads the external reservation or payment page, while optionally displaying the guidance text in a separate panel, overlay, or preceding page.
Input: redirect response with external URL and optional guidance content or link.
Output: an external site page rendered on the terminal and, if provided, contextual guidance visible to the user.

User then interacts directly with the external site's interface to complete the reservation or purchase process, using the guidance information to reduce errors and confusion.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional reservation aggregation systems typically retrieve structured reservation records from multiple data sources and present them to end users in a simple list or table. In such systems, the server-side processing is largely limited to basic query execution, field mapping, and static sorting. As a result, these systems suffer from several technical drawbacks in terms of computer technology itself.

First, when heterogeneous reservation data is obtained from multiple external sources, each using different field names, formats, and levels of completeness, existing servers frequently perform ad hoc transformations on the fly for each client request. This leads to repeated parsing, normalization, and comparison operations over similar data, causing redundant use of processor cycles, inefficient memory utilization, and increased latency under high load.

The lack of a unified internal data structure for cross-source comparison makes it difficult for the processor to perform optimized indexing, caching, and reuse of previously acquired reservation information.

Second, conventional systems do not effectively exploit generative learning models for machine-generated analysis and control of reservation information. In typical usage, such models are invoked manually or in an unstructured manner, consuming substantial computational resources with poorly defined prompts and responses. The absence of a structured prompt-generation mechanism on the server side causes inconsistent analysis quality, unnecessary network traffic to external model providers, and additional processing overhead for filtering and post-processing generated content.

Third, traditional architectures place a substantial interpretive burden on the client terminal or the human user, rather than on the server. Users must manually interpret differences in prices, available time slots, and cancellation policies across multiple sources, which may lead to repeated user interactions and further requests to the server for clarification, re-sorting, or filtering. This results in increased round-trip communications, fragmented query patterns, and duplicated computations across similar user sessions.

Fourth, existing systems do not employ the generative learning model as an integrated control component for orchestrating data acquisition and transaction execution. Server logic generally contains rigid, hand-coded workflows for calling external APIs and redirecting users to external providers. These workflows are not easily adaptable to new data sources, altered provider requirements, or personalized transaction policies, and they require extensive code changes and redeployments, which degrades maintainability and scalability of the server-side platform.

Accordingly, there is a need for a technical solution that improves the operation of computer systems for multi-source reservation comparison. Such a solution should: (i) normalize heterogeneous reservation data into a unified internal representation suitable for high-performance comparison, storage, and retrieval; (ii) integrate a generative learning model into the server's processing pipeline via structured prompt sentences so that advantages and disadvantages of reservation options are programmatically analyzed; and (iii) leverage such generative outputs to drive both explanation to users and control of data acquisition and transaction workflows, thereby reducing redundant computations, improving resource utilization, and lowering end-to-end latency.

The specific processing by the specific processing unit 290 of the data processing device 12 in Application Example 1 is realized by the following means.

The present invention provides a server comprising a processor configured to acquire, via an information processing terminal, a designation of a facility input by a user, generate search instruction information including the designation of the facility, and transmit, on the basis of the search instruction information, communication requests to response programs of a plurality of information providing sources so as to acquire reservation information relating to the facility; normalize the reservation information acquired from the plurality of information providing sources into a common attribute format including price information, available time information, cancellation condition information, and identification information of the information providing source, and integrate the normalized reservation information into a data structure for comparison; store the integrated reservation information in a storage device, acquire, from the storage device, a group of reservation information corresponding to the designation of the facility, and generate comparison display information by performing at least sorting or extraction on the group of reservation information on the basis of at least the price information and the available time information; transmit the comparison display information to the information processing terminal so as to cause the information processing terminal to visually display the reservation information in a list format and to receive from the information processing terminal a selection operation by the user for particular reservation information; generate guidance information for guiding the user to a reservation confirmation screen on a provider side outside the server that corresponds to the selected reservation information, and transmit the guidance information to the information processing terminal so as to guide the user to a reservation confirmation process on the provider side; generate, for a generative learning model, a prompt sentence including at least one of the comparison display information and the group of reservation information, cause the generative learning model to analyze advantages and disadvantages of the reservation information on the basis of the prompt sentence, acquire an analysis result from the generative learning model, and generate explanation information to be presented to the user on the basis of the analysis result; and generate, for the generative learning model, a prompt sentence based on the reservation information selected by the user, the prompt sentence instructing execution of a transaction, and generate, on the basis of the prompt sentence, control information that instructs execution of a transaction process on the provider side outside the server. This enables the server to convert heterogeneous multi-source reservation data into an optimized internal structure for comparison, to offload complex evaluative analysis and workflow control to a generative learning model via structured prompt sentences, and thereby to improve computational efficiency, scalability, and responsiveness of the reservation aggregation platform while reducing redundant processing and network interactions.

The term “system” refers to a combination of hardware and software components configured to perform acquisition, processing, storage, analysis, and presentation of reservation information, including at least a server and one or more information processing terminals.

The term “server” refers to an information processing apparatus including at least one processor, memory, storage, and communication interface, configured to execute programs that implement acquisition, normalization, storage, analysis, and distribution of reservation information to one or more information processing terminals.

The term “processor” refers to one or more hardware processing units, such as a central processing unit or an execution core, configured to execute machine-readable instructions to perform logical operations, arithmetic operations, data transfer operations, and control operations described in the claims.

The term “information processing terminal” refers to any user-operated computing device, such as a smartphone, tablet, or personal computer, configured to transmit user input to the server, receive data from the server, and present information through a display or other output interface.

The term “user” refers to a human operator or an organization that interacts with the information processing terminal to input a facility designation, review reservation information, and select particular reservation information for a transaction.

The term “facility” refers to any reservable resource or service location, including but not limited to restaurants, lodging facilities, event venues, transportation services, or other service-providing entities.

The term “designation of a facility” refers to information entered by the user that identifies a particular facility, such as a facility name, identifier, keyword, or combination of such elements.

The term “search instruction information” refers to control information generated by the processor that specifies at least the designation of a facility and is used to trigger acquisition of reservation information from one or more information providing sources.

The term “information providing source” refers to any external data provider, such as an online platform, database, or web service, that supplies reservation information related to one or more facilities via a communication network.

The term “response program” refers to a software component or service interface provided by an information providing source, such as an application programming interface, that accepts communication requests and returns reservation information.

The term “communication request” refers to a message transmitted from the server to an information providing source, using a communication protocol, that requests reservation information for a designated facility.

The term “reservation information” refers to data indicating conditions and parameters of a possible reservation for a facility, including at least price information, available time information, cancellation condition information, and provider-related identifiers.

The term “price information” refers to data indicating a monetary amount or cost associated with a reservation option for a facility, optionally including currency or pricing conditions. The term “available time information” refers to data indicating one or more time slots, dates, or periods during which a reservation for a facility can be made or used.

The term “cancellation condition information” refers to data indicating terms under which a reservation may be cancelled, including any deadlines, penalties, fees, or refund conditions. The term “identification information of the information providing source” refers to data that uniquely or distinguishably identifies an information providing source, such as a provider name, provider identifier, or endpoint identifier.

The term “common attribute format” refers to a standardized internal data schema defined by the server, in which reservation information from multiple information providing sources is represented using unified field names, data types, and structures suitable for comparison. The term “normalize” refers to processing by the processor that converts heterogeneous reservation information from different formats and field definitions into the common attribute format.

The term “data structure for comparison” refers to an internal representation of normalized reservation information, such as an array, list, table, or collection, that is optimized for comparative operations including sorting and filtering across multiple reservation options. The term “storage device” refers to a hardware component or subsystem, such as a magnetic disk, solid-state drive, or non-volatile memory, used to store integrated reservation information and related data in a non-transitory manner.

The term “group of reservation information” refers to a set of one or more reservation information records retrieved from the storage device that correspond to a common designation of a facility.

The term “comparison display information” refers to processed data derived from the group of reservation information, arranged and formatted so that differences in attributes such as price and available time can be compared when displayed on an information processing terminal.

The term “sorting” refers to an operation performed by the processor that arranges reservation information records in a particular order based on one or more attributes, such as ascending price or earliest available time.

The term “extraction” refers to an operation performed by the processor that selects a subset of reservation information records from the group of reservation information based on specified conditions, such as price thresholds or cancellation conditions.

The term “list format” refers to a display layout in which multiple reservation options are presented as a sequence of items, each item including at least a portion of the reservation information, enabling side-by-side or sequential comparison.

The term “selection operation” refers to an input action by the user, such as a touch, click, or other interaction on the information processing terminal, that indicates choice of particular reservation information from those displayed.

The term “guidance information” refers to control data generated by the processor that enables the information processing terminal to direct the user to a reservation confirmation screen or transaction interface provided by an external provider.

The term “provider side” refers to a computing environment or system operated by an external provider or information providing source, outside the server, that executes reservation confirmation or transaction processes.

The term “reservation confirmation screen” refers to a user interface provided on the provider side through which a user can confirm and finalize a reservation corresponding to selected reservation information.

The term “generative learning model” refers to a machine learning model, such as a generative artificial intelligence model, configured to output text or other data based on prompt sentences and underlying learned parameters.

The term “prompt sentence” refers to a text string or structured input generated by the processor and supplied to the generative learning model, the text string specifying instructions, context, and data for analysis or generation.

The term “analysis result” refers to output generated by the generative learning model in response to a prompt sentence, including but not limited to evaluations, summaries, or characterizations of advantages and disadvantages of reservation information.

The term “explanation information” refers to processed content, derived from the analysis result of the generative learning model, that is suitable for display to the user to assist in understanding and comparing reservation options.

The term “control information” refers to data generated by the processor that specifies operations to be executed in a transaction process on the provider side, such as parameters, instructions, or workflow triggers.

The term “transaction process” refers to a sequence of operations executed on the provider side, including reservation confirmation and optional payment processing, that results in a finalized reservation or purchase based on selected reservation information.

The term “acquisition control information” refers to control information that instructs acquisition of reservation information from a plurality of information providing sources according to specified conditions derived from a prompt sentence.

The term “transaction control information” refers to control information that instructs execution of a direct transaction at an external provider, generated by or based on output of the generative learning model in response to a prompt sentence.

The server implements embodiments of the invention using a combination of hardware and software configured to optimize acquisition, normalization, comparison, and presentation of reservation information, and to cooperate with a generative AI model via structured prompt sentences.

The server includes at least one processor, a main memory, a non-transitory storage device, and a network interface. The server runs an operating system such as a general-purpose server operating system and application software implemented using a runtime environment such as a server-side scripting platform. The server may use a web framework as a routing and middleware layer, and may use a document-oriented database such as a NoSQL database (for example, a database compatible with a document collection model) stored on a solid-state drive. The server connects to external information providing sources via a communication network using a protocol such as HTTPS.

The terminal includes a processor, a memory, a touch-sensitive display, and a wireless communication interface such as a Wi-Fi or cellular modem. The terminal runs a client-side application implemented using a cross-platform user interface framework such as a mobile UI framework comparable to React Native. The terminal presents graphical user interface components (for example, text input fields, list views, touchable elements) to the user, transmits user input to the server, and displays data received from the server.

The user operates the terminal to input a designation of a facility, such as a restaurant, lodging facility, or other reservable resource. The terminal converts the user's input into a text string and transmits the text string to the server as part of a request message. The terminal receives response messages from the server and renders reservation options in a structured, comparison-oriented layout that reflects pre-processed and normalized data computed on the server.

The server receives the designation of the facility and generates search instruction information that specifies the facility name and optional search parameters such as date range, number of persons, or location constraints. The server uses the search instruction information to construct communication requests to multiple external information providing sources. Each communication request may target a specific application programming interface exposed by a source, using source-specific query parameters and authentication tokens.

The server performs data processing operations that are not limited to simple forwarding of user input. The server parses heterogeneous responses from multiple sources and normalizes the reservation information into a common internal schema. The server converts different field names and formats (for example, various price formats and date-time formats) into unified attribute names and canonical representations. The server uses an internal data structure such as a structured array or collection of normalized reservation objects, where each object contains standardized fields: facility identifier, provider identifier, normalized price value in a base currency, available time slots as normalized timestamps, encoded cancellation rules, and a provider-side redirect URL.

The server stores these normalized reservation objects in the database, indexed at least by facility identifier, provider identifier, and normalized price. The server thereby enables efficient subsequent queries, reuse of data across user sessions, and reduction of redundant calls to external providers. By operating on the normalized internal data structure, the server can execute sorting and filtering operations using index-based queries and in-memory operations, which reduce processing time and memory usage compared to repeatedly parsing raw responses from multiple external providers.

The server cooperates with a generative AI model by generating prompt sentences that embed the normalized reservation information in a structured yet textual manner. The server uses a generative AI model that may be implemented as a transformer-based neural network having multiple self-attention layers, feedforward layers, and layer normalization components. The generative AI model uses learned weight parameters trained on large-scale text corpora, and may be fine-tuned on domain-specific data such as reservation-related descriptions and policy statements. The model operates on tokenized sequences of text, where each token is mapped to an embedding vector, and internal multi-head attention mechanisms compute context-sensitive representations.

The server constructs prompt sentences that explicitly identify the relevant attributes of reservation options. For example, the server may generate a prompt sentence such as: “Analyze the following reservation options for the facility named ‘Restaurant A’. Each option includes price, available time slots, and cancellation policy. Identify the advantages and disadvantages of each option, and indicate which option is best for a user who prioritizes low price and flexible cancellation. Option 1: price 3000 JPY, available times 18:00 and 20:00, free cancellation until 24 hours before. Option 2: price 3500 JPY, available times 19:00 and 21:00, cancellation fee after booking. Option 3: price 3200 JPY, available times 18:30 and 20:30, free cancellation until 12 hours before.”

The server transmits this prompt sentence to the generative AI model. Inside the generative AI model, the transformer layers compute attention scores between tokens representing different attributes (such as “price 3000 JPY” and “free cancellation until 24 hours before”) and tokens representing the instructions (“prioritizes low price and flexible cancellation”). The model uses these attention patterns, together with its learned weight parameters, to generate an output text that describes, for each option, the relative advantages and disadvantages and a recommended option.

The server receives the output text as an analysis result and post-processes the text to generate explanation information for the user. The server may apply rule-based parsing to highlight specific phrases indicating best price, more flexible cancellation, or better time coverage. The server attaches the explanation information to the comparison display information so that the terminal can render both numerical comparisons and natural-language guidance.

The server further uses the generative AI model to support control logic related to acquisition and transaction processes. For example, the server may generate a prompt sentence such as: “Generate acquisition instructions for retrieving reservation information for the facility named ‘Restaurant A’ from multiple providers. The providers are: Provider A, Provider B, and Provider C. For each provider, specify which parameters should be requested (date, time, number of people) and which filters should be applied (maximum price, cancellation flexibility). Provide the result as concise textual instructions.”

The server receives the generated instructions and converts them into structured acquisition control information, by mapping textual references to specific providers and parameters into concrete API call configurations. This conversion can be implemented by pattern matching and template-based parsing, which transform the generative AI model's logical planning into specific endpoint URIs, query parameters, or payload fields. As a result, the server adapts its acquisition strategy to changing requirements or provider sets without requiring deep modification of core code, while still performing concrete computer-level operations such as altering network request patterns, timeouts, and filtering thresholds.

The server may also generate a prompt sentence to control transaction processes, for example:
“Based on the following selected reservation option: price 3000 JPY, provider ‘Provider A’, reservation time 19:00, free cancellation until 24 hours before, generate instructions for executing a direct transaction with the provider's system. Indicate the necessary fields (user identifier, facility identifier, time slot, payment method) and any required confirmation steps.”

The server interprets the generated instructions and generates transaction control information that specifies how to construct the redirect URL, which parameters to include as query parameters or POST payload fields, and how to handle confirmation callbacks from the provider side. The server thus uses the generative AI model not only for descriptive analysis but also for planning and configuring sequences of machine-level network transactions. The server achieves technical improvements over conventional systems by combining normalized data structures, generative AI planning, and optimized storage and indexing. Because the server normalizes reservation information into a common attribute format and stores it in an indexed database, the server reduces the need for repeated parsing and transformation of raw external responses. This reduces processor cycles for repeated requests concerning the same facility, improves cache efficiency, and lowers average response time. The use of indexed queries and pre-computed comparison data structures enables faster sorting and filtering operations, thereby improving throughput under high load.

The server further reduces communication load by caching normalized reservation information and by using generative AI outputs to avoid redundant calls to external providers. For example, when the generative AI model indicates that certain providers have systematically higher prices under particular conditions, the server can adjust acquisition control information to deprioritize or skip some providers for certain query patterns, thereby reducing the total number of external API requests and associated network traffic.

The generative AI model is trained or fine-tuned using supervised or reinforcement learning methods. The server may access a training subsystem where historical reservation data, user choices, and provider responses form training examples. The training procedure may use a loss function such as cross-entropy between generated tokens and target explanation or instruction tokens, or a reward-based metric reflecting alignment with user preferences and successful transaction rates. The model's weights are updated using gradient descent-based optimization methods such as Adam, with learning rate schedules and regularization parameters. The server may periodically deploy updated model parameters, improving the quality and efficiency of analysis and control over time.

The server can optionally apply data augmentation techniques to expand the training dataset, such as paraphrasing textual descriptions of cancellation policies, generating synthetic combinations of price and time attributes, or simulating provider response variations. These techniques increase robustness of the generative AI model to diverse input patterns and reduce error rates in downstream analysis.

The server employs non-conventional processing sequences that differ from typical rule-based comparison engines. Instead of hard-coding fixed ranking rules, the server relies on the generative AI model's capability to process multi-attribute trade-offs through its learned attention patterns and internal representations. For example, the generative AI model can infer that, for a given user profile, a slightly higher price may be acceptable if cancellation is significantly more flexible, without requiring explicit weighting rules defined by programmers. The server then converts this nuanced, context-aware evaluation into explanation information and, optionally, into selection hints or default recommendations. The server and terminal together implement a data flow that supports multiple embodiments. In one embodiment, the server directly communicates with an external generative AI service via an API and interprets returned text. In another embodiment, the server hosts an on-premise generative AI model executed on specialized hardware such as a GPU or tensor processing unit, thereby reducing latency and network dependence. In yet another embodiment, the server uses a smaller distilled generative AI model for real-time analysis and offloads more computationally intensive tasks to a larger remote model when resources permit.

The terminal does not perform complex normalization or AI-based analysis, which offloads heavy computation to the server. The terminal instead focuses on responsive user interface rendering and minimal data transformation, which conserves battery life and processing resources on constrained devices. The separation of concerns allows the server to centralize advanced optimization techniques, such as caching normalized data structures, balancing loads across multiple processors, and reusing AI-generated instructions across user sessions. The user experiences shortened response times and higher reliability because the server maintains a unified, indexed store of normalized reservation information and because the generative AI model's outputs reduce the need for multiple interactive refinements. The user does not manually compare all combinations of price, time, and cancellation policy for every provider; instead, the server and generative AI model generate prioritized explanations and suggestions, reducing user-induced repetitive requests and thereby further improving overall system efficiency.

The server achieves technical effects beyond simple automation of human judgment by changing the way the underlying computer system manages data and network interactions. By normalizing data into a common attribute format and by using generative AI outputs as machine-readable control hints for acquisition and transaction processes, the server reduces redundant computation, improves cache hit rates, optimizes query planning, and lowers communication overhead. These improvements arise from specific data structures, indexing strategies, generative prompt designs, and rule-based interpretations of AI outputs, rather than from mere rephrasing of human decision-making in machine form.

The embodiments can be varied in multiple ways. The server may support additional attributes such as user ratings, provider reliability scores, or geographic distance, and may extend the common attribute format accordingly. The generative AI model may incorporate additional tokens describing user preferences or device capabilities to tailor analysis and instructions. The terminal may present explanation information as text, icons, or color-coded indicators derived from the generative AI output.

The server can also adjust threshold rules for when to refresh reservation data from providers versus when to serve cached normalized data. These rules can be updated in part based on generative AI recommendations that consider historical volatility of provider offerings, enabling the server to avoid unnecessary data refresh operations while still maintaining acceptable accuracy. This balancing further reduces network load and database write operations, contributing to technical improvements in system performance and resource utilization.

In all embodiments, the server, terminal, and user cooperate in a way that is grounded in concrete computer operations: structured acquisition of heterogeneous data via network interfaces, transformation into a common attribute format using specific data structures and algorithms, storage and retrieval using indexed queries on a database, and controlled interaction with a generative AI model using carefully designed prompt sentences. These operations provide a technical solution that enhances the functioning of the computer system itself, including faster processing, reduced communication overhead, and more efficient use of compute and memory resources, rather than merely automating a pre-existing human workflow.

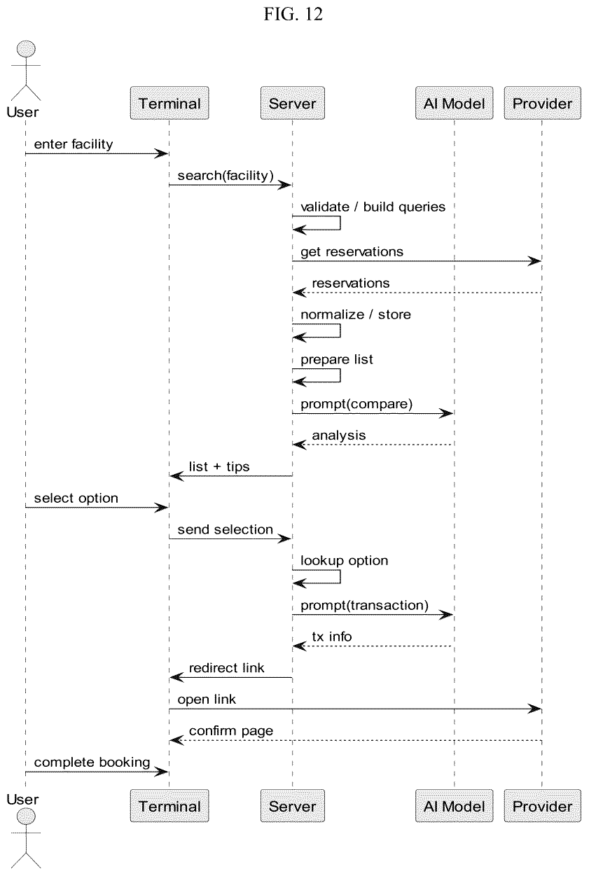

The following describes the processing flow using FIG. 12.

### Step 1:

The user operates the terminal to input a designation of a facility.

The user enters, via a text input field on the terminal, a facility name such as “Restaurant A,” optionally together with parameters such as desired date, time range, and number of people. The terminal receives this input as character strings and numerical values, and stores them in local variables or state.
Input: raw keystrokes or touch events from the user.
Output: a structured input object on the terminal, for example a combination of a facility name string and optional parameter values ready to be sent to the server.

### Step 2:

The terminal transmits a search request to the server.

The terminal constructs a request message including the facility designation and optional parameters, and sends it to the server via a network interface using a protocol such as HTTPS.

The terminal may attach device identifiers or session tokens for context.
Input: the structured input object from Step 1.
Output: a network request packet carrying the facility designation and parameters, sent over the communication network to the server.

### Step 3:

The server receives and validates the search request.

The server accepts the incoming request through a network interface and a request handler implemented in server-side software.

The server parses the request body, extracts the facility designation and parameters, and checks for validity (non-empty name, valid date format, acceptable range of persons).
Input: the network request packet from the terminal.
Output: a validated search instruction object in server memory, including the facility designation and normalized search parameters.

### Step 4:

The server generates search instruction information and constructs communication requests to multiple information providing sources.

The server creates an internal data structure representing search instruction information, including the facility designation, date-time constraints, and user-related context.

The server maps this information to provider-specific query formats and builds outgoing request messages for each information providing source, such as different endpoints and parameter sets.
Input: the validated search instruction object from Step 3.
Output: a set of provider-specific request messages ready to be transmitted to external information providing sources.

### Step 5:

The server transmits communication requests and acquires heterogeneous reservation information from multiple information providing sources.

The server sends each provider-specific request through the network interface, waits for responses within configured timeouts, and collects the responses as they arrive.

The server decodes each response (for example, JSON or XML) and extracts reservation-related fields, even if they differ in naming and structure among providers.
Input: the set of provider-specific request messages from Step 4.
Output: a collection of raw reservation response objects, each corresponding to a different information providing source and containing heterogeneous field structures.

### Step 6:

The server normalizes the heterogeneous reservation information into a common attribute format.

The server iterates over the raw reservation response objects, maps provider-specific field names to standard field names, converts currency strings into normalized numeric price values, and transforms date-time strings into standardized timestamps.

The server encodes cancellation conditions into a consistent representation (for example, structured rules with deadlines and penalty amounts).
Input: the collection of raw reservation response objects from Step 5.
Output: a set of normalized reservation records, each having standardized attributes such as facility identifier, provider identifier, normalized price, available time slots, cancellation rules, and redirect URL.

### Step 7:

The server integrates the normalized reservation records into a data structure for comparison and stores them in a storage device.

The server groups the normalized records by facility designation and constructs a comparison-oriented data structure, such as an array or list of records associated with the requested facility.

The server writes these records into a database on the storage device, creating or updating entries indexed by facility and provider identifiers.
Input: the set of normalized reservation records from Step 6.
Output: stored and indexed reservation records in the database, and an in-memory comparison data structure associated with the facility designation.

### Step 8:

The server retrieves a group of reservation records for the facility and performs sorting or extraction operations.

The server queries the database using the facility designation as a key, fetches all matching normalized records, and loads them into memory.

The server sorts the records by one or more attributes (for example, ascending price, earliest available time) and optionally filters them according to conditions such as maximum price or minimum cancellation flexibility.
Input: the facility designation and database-stored reservation records from Step 7.
Output: an ordered and possibly filtered group of reservation records forming comparison display information.

### Step 9:

The server generates comparison display information to be sent to the terminal.

The server formats the ordered group of reservation records into a structure suitable for display, adding computed labels such as “lowest price” or “most flexible cancellation.” The server prepares a response payload that contains only the fields needed by the terminal, reducing unnecessary data to lower communication load.
Input: the ordered and filtered group of reservation records from Step 8.
Output: a comparison display information object encapsulating the reservation options and associated display attributes.

### Step 10:

The server generates a prompt sentence for a generative AI model based on the comparison display information.

The server converts key attributes of each reservation option (price, available time slots, cancellation rules, and provider identifiers) into a textual description embedded in an instruction sentence.

The server assembles a prompt sentence that instructs the generative AI model to analyze advantages and disadvantages of each option and, optionally, to identify a recommended option according to specified criteria.
Input: the comparison display information object from Step 9.
Output: a structured prompt sentence in natural language, ready to be submitted to the generative AI model.

### Step 11:

The server submits the prompt sentence to the generative AI model and receives an analysis result.

The server sends the prompt sentence to the generative AI model through an internal interface or external service API.

The generative AI model processes the prompt using its neural network layers, computes context-aware attention over the reservation attributes and instructions, and generates an output text describing pros and cons and recommendations.

The server receives this output text as the analysis result.
Input: the prompt sentence from Step 10.
Output: an analysis result text that evaluates each reservation option and may recommend one or more options.

### Step 12:

The server transforms the analysis result into explanation information suitable for display to the user.

The server parses the analysis text, identifies phrases indicating relative benefits (for example, “cheapest,” “most flexible,” “earliest time”), and associates those phrases with specific reservation records in the comparison display information.

The server constructs structured explanation information, such as description strings linked to particular options or overarching summary text.
Input: the analysis result text from Step 11 and the comparison display information from Step 9.
Output: explanation information objects that reference reservation options and contain user-readable descriptions of advantages and disadvantages.

### Step 13:

The server transmits the comparison display information and associated explanation information to the terminal.

The server packages the reservation options and the explanation information into a response payload and sends it over the network to the terminal.

The server may compress or otherwise optimize the payload to reduce bandwidth usage.
Input: the comparison display information and explanation information from Steps 9 and 12.
Output: a network response packet carrying structured reservation options and explanatory text to the terminal.

### Step 14:

The terminal receives and displays the reservation options and explanation information. The terminal parses the received payload, stores the reservation options and associated explanation text in its local memory, and renders a list view on the display.

The terminal visually indicates attributes such as price and available time and may highlight options recommended by the explanation information.
Input: the network response packet from Step 13.
Output: a graphical representation on the terminal's display, showing reservation options and explanatory text for user review.

### Step 15:

The user reviews the displayed information and selects a particular reservation option.

The user scrolls through the list on the terminal and taps or clicks on an item that matches the user's preference, such as the option marked as having the best balance between price and cancellation flexibility.

The terminal detects the selection event and identifies which reservation record corresponds to the selected list item.
Input: user touch or click events on the terminal display.
Output: a selected reservation identifier or corresponding reservation record on the terminal.

### Step 16:

The terminal transmits selection information to the server.

The terminal constructs a selection request containing the selected reservation identifier and, optionally, contextual information such as the current session ID.

The terminal sends this selection request to the server via the network interface.
Input: the selected reservation identifier from Step 15.
Output: a network request packet carrying selection information to the server.

### Step 17:

The server retrieves the selected reservation record and generates guidance information for transaction.

The server receives the selection request, extracts the reservation identifier, and queries the database or in-memory cache to retrieve the detailed reservation record.

The server reads the provider identifier and redirect URL from the record, and constructs guidance information such as a redirect link or token that leads to the provider-side reservation confirmation screen.
Input: the selection request packet from Step 16 and the stored reservation records in the database.
Output: guidance information including at least a redirect destination or transaction endpoint associated with the selected reservation.

### Step 18:

The server optionally generates a transaction-related prompt sentence for the generative AI model based on the selected reservation.

The server composes a prompt sentence that summarizes the selected reservation attributes and instructs the generative AI model to output transaction parameters or steps required by the provider.

The server submits this prompt to the generative AI model and receives a response containing recommended transaction fields or sequence.

The server maps this response into transaction control information that may refine the guidance information, such as by adding specific query parameters or required user input items.
Input: the selected reservation record from Step 17.
Output: transaction control information derived from a transaction-related prompt sentence and the generative AI model's output.

### Step 19:

The server sends the guidance information, and optionally transaction control information, to the terminal.

The server constructs a response that includes the redirect link and any additional parameters or instructions needed to initiate the provider-side transaction.

The server transmits this response via the network interface to the terminal.
Input: the guidance information and optional transaction control information from Steps 17 and 18.
Output: a network response packet enabling the terminal to guide the user to the provider-side reservation confirmation process.

### Step 20:

The terminal guides the user to the provider-side reservation confirmation screen.

The terminal receives the response, extracts the redirect link and any associated parameters, and opens a web browser or embedded web view pointing to the provider's transaction endpoint.

The terminal passes necessary information (such as reservation ID, time slot, or user session token) as part of the request to the provider's system.
Input: the response packet from Step 19.
Output: an active connection from the terminal to the provider-side reservation confirmation screen, presented on the terminal's display.

### Step 21:

The user completes the reservation on the provider side.

The user interacts with the provider's interface, enters any remaining details (for example, payment information or special requests), and confirms the reservation.

The provider's system finalizes the transaction and may return a confirmation screen or message that the terminal displays to the user.
Input: user interactions within the provider-side interface.
Output: a finalized reservation transaction at the provider side and a confirmation presented to the user on the terminal.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional reservation aggregation systems primarily function as static intermediaries that retrieve reservation information from multiple data sources and render the information as simple lists for user selection. In such systems, a processor typically executes straightforward retrieval and display operations, while leaving complex comparison, interpretation, and decision support to the human user. As a result, the user is required to manually interpret heterogeneous data items, such as price, available time periods, and cancellation conditions, which are often presented in inconsistent formats across different external sources. This leads to increased cognitive load, higher likelihood of user error, and inefficiencies in reaching an optimal reservation decision.

In existing architectures, the processor generally treats external information sources and client devices as passive endpoints. The processor does not dynamically normalize and structure heterogeneous reservation data into a unified comparison model, and does not leverage machine-generated natural-language explanations to assist the user in understanding nuanced trade-offs among multiple reservation options. Consequently, the user must repeatedly navigate between different sites, interpret domain-specific terms, and mentally reconcile non-uniform representations of reservation conditions, which degrades overall system usability and performance.

Furthermore, conventional systems do not integrate generative artificial intelligence models into the core data processing pipeline in a structured and controllable manner. While a generative artificial intelligence model could, in principle, be used to summarize or compare reservation options, typical solutions do not define a systematic mechanism by which a processor generates prompt sentences based on structured comparison data, sends the prompt sentences to the generative model, and then reliably incorporates the generated explanations and purchase guidance back into the interactive flow. Without such a mechanism, any use of generative artificial intelligence tends to be ad hoc, non-repeatable, and difficult to verify or scale from the perspective of system architecture.

Additionally, many conventional systems provide only a simple redirect function to external reservation sites without integrating that redirect action with a machine-generated explanation of the implications of the user's choice. The user is often redirected without a clear, system-generated description of what specific purchase process will occur at the external site, what constraints or cancellation conditions apply, or how that option compares to other available options just prior to the redirect. This gap can lead to user mistrust, abandoned transactions, and suboptimal use of network and computing resources.

There is therefore a need for an improved computer-implemented system in which the processor not only acquires reservation information from multiple external information provision sources, but also (i) normalizes and structurally compares that information according to predetermined criteria, (ii) generates rich, context-specific prompt sentences for a generative artificial intelligence model based on the normalized comparison data and user selections, and (iii) uses the generated explanations and purchase guidance as integral parts of the user interface and redirect workflow. Such an architecture would improve the functioning of the computer system itself by transforming a passive retrieval-and-display pipeline into an interactive, AI-assisted decision-support engine that systematically orchestrates data acquisition, normalization, comparison, natural-language explanation, and controlled redirection.

Accordingly, a technical problem to be solved by the invention is to provide a system and processor configuration that: efficiently acquires heterogeneous reservation information from multiple external information provision sources based on identification information of an accommodation target; converts the acquired information into normalized analysis data suitable for machine processing; generates comparison data for ranking and listing reservation options; and, by interaction with a generative artificial intelligence model through structured prompt sentences, produces explanation sentences and purchase guidance information that are tightly integrated into the system's control flow. This configuration aims to reduce user cognitive load, improve accuracy and consistency of reservation decisions, and enhance the overall throughput and reliability of the reservation aggregation process as a computer technology.

The specific processing by the specific processing unit 290 of the data processing device 12 in Example 2 is realized by the following means.

The present invention provides a server comprising a processor configured to receive, from an information processing terminal, identification information of an accommodation target input by a user via an input/output screen of the information processing terminal; execute, based on the identification information, an information acquisition process to obtain reservation information related to the accommodation target from a plurality of external information provision sources via a communication network; analyze the obtained reservation information to convert the reservation information into structured analysis data and store the analysis data in a storage device; normalize price information, available time period information, and cancellation condition information included in the analysis data; generate comparison data by classifying or ranking the reservation information according to predetermined comparison criteria; generate screen information for causing the reservation information to be displayed in a list format on the information processing terminal based on the comparison data, and transmit the screen information to the information processing terminal; obtain connection destination information of an external information provision source associated with selected reservation information based on identification information of the selected reservation information among a plurality of pieces of reservation information displayed in the list format, the identification information being received from the information processing terminal; cause the information processing terminal to be redirected to the connection destination information; transmit, to a generative artificial intelligence model, a prompt sentence including the comparison data and the identification information of the accommodation target, and cause the generative artificial intelligence model to generate an explanation sentence describing advantages and disadvantages of the plurality of pieces of reservation information; output the generated explanation sentence to the information processing terminal in association with the display in the list format; transmit, to the generative artificial intelligence model, a prompt sentence instructing execution of a purchase process based on the selected reservation information; cause the generative artificial intelligence model to generate purchase guidance information describing contents of the purchase process at the external information provision source; and output the generated purchase guidance information to the information processing terminal. This enables the computer system to operate as an integrated reservation aggregation and decision-support platform in which heterogeneous reservation data from multiple external information provision sources is normalized and structurally compared by the processor, and in which interaction with the generative artificial intelligence model is orchestrated through processor-generated prompt sentences that are derived from the comparison data and user selections, thereby improving the technical functioning of the system by reducing user-side processing, enhancing consistency of interpretation of reservation conditions, and providing machine-generated explanations and purchase guidance tightly coupled to the redirect and purchase workflow.

The term “system” refers to an arrangement of one or more computing devices, communication networks, and storage resources collectively configured to execute the functions described in the claims.

The term “server” refers to an information processing apparatus, typically including at least one processor, memory, and a communication interface, that provides processing services and data to one or more information processing terminals over a communication network. The term “processor” refers to one or more hardware processing units, such as a central processing unit or a processing core, capable of executing instructions to perform arithmetic, logical, control, and input/output operations.

The term “information processing terminal” refers to an electronic device operated by a user, such as a personal computer, a mobile terminal, or a tablet device, that is capable of communicating with the server and displaying information through an input/output screen. The term “user” refers to a human operator who interacts with the information processing terminal to input information, receive displayed information, and perform reservation and purchase actions.

The term “input/output screen” refers to a graphical user interface provided on a display unit of the information processing terminal, through which the user can input information and view information output by the server.

The term “identification information of an accommodation target” refers to information used to specify a particular accommodation-related object, such as a lodging facility, a stay service, or a reservation subject, including but not limited to a name, code, or textual descriptor.

The term “reservation information” refers to information related to reservation conditions for the accommodation target, including at least price information, available time period information, and cancellation condition information, and optionally additional terms or attributes.

The term “external information provision source” refers to a computer system, service, or data provider, distinct from the server, that supplies reservation information via a communication network, such as an external database, a reservation platform, or a service provider system.

The term “communication network” refers to any wired or wireless data communication infrastructure, including the Internet, local area networks, wide area networks, or mobile communication networks, used to exchange data between the server, the information processing terminal, and external information provision sources.

The term “information acquisition process” refers to a sequence of processing operations executed by the processor to obtain reservation information from one or more external information provision sources based on the identification information of the accommodation target.

The term “analysis data” refers to structured data generated by the processor by converting reservation information obtained from external information provision sources into a normalized and machine-readable format suitable for further computation and comparison.

The term “storage device” refers to any non-transitory storage medium, such as a semiconductor memory, a magnetic storage unit, or an optical storage unit, capable of storing analysis data, comparison data, screen information, and other related information.

The term “price information” refers to data representing a monetary cost associated with a reservation option for the accommodation target, including base prices, fees, or other pricing components expressed in numeric or textual form.

The term “available time period information” refers to data representing a time range or time slot during which the accommodation target is reservable or usable, such as check-in and check-out times, or start and end times of service availability.

The term “cancellation condition information” refers to data representing terms and constraints associated with cancellation of a reservation, such as deadlines for free cancellation, penalties, or refund conditions.

The term “normalize” refers to processing operations that convert heterogeneous reservation information from multiple external information provision sources into a consistent, standardized format, including unifying units, formats, and representations to enable structured comparison.

The term “comparison data” refers to data generated by the processor by classifying, ranking, or otherwise organizing normalized reservation information according to predetermined comparison criteria, such as price, available time period, and cancellation conditions. The term “predetermined comparison criteria” refers to one or more rules or parameters defined in advance, specifying how reservation information is to be evaluated, sorted, or ranked, including but not limited to lowest price, most flexible cancellation conditions, or preferred time periods.

The term “screen information” refers to data representing a user interface layout and content, such as list structures, text, and interactive elements, generated by the processor for display on the information processing terminal.

The term “list format” refers to a display format in which multiple pieces of reservation information are arranged as a sequence of items, entries, or records that can be visually compared by the user.

The term “selected reservation information” refers to a reservation option chosen by the user from among a plurality of pieces of reservation information displayed in the list format on the information processing terminal.

The term “identification information of the selected reservation information” refers to data, such as an identifier or key, that uniquely associates the selected reservation information with its corresponding record in the system or with an external information provision source.

The term “connection destination information” refers to data specifying an access endpoint of an external information provision source, such as a network address or resource locator, used to direct the information processing terminal to a site or interface for completing a reservation or purchase.

The term “redirect” refers to a process in which the server causes the information processing terminal to transition from accessing the server to accessing a connection destination associated with an external information provision source, typically by sending a redirect response or link.

The term “generative artificial intelligence model” refers to a machine learning model, such as a generative language model, configured to generate text or other content based on input data and instructions provided through a prompt sentence.

The term “prompt sentence” refers to an input text or structured instruction supplied to the generative artificial intelligence model, which describes a task, context, or data for which the model is to generate corresponding output.

The term “explanation sentence” refers to natural-language text generated by the generative artificial intelligence model in response to a prompt sentence, describing advantages, disadvantages, or other characteristics of one or more pieces of reservation information. The term “purchase guidance information” refers to natural-language text or structured content generated by the generative artificial intelligence model that explains or guides the user through the purchase process at an external information provision source, including steps, conditions, and important considerations.

The term “acquisition instruction information” refers to data specifying acquisition conditions, retrieval parameters, and acquisition destinations for reservation information to be obtained from each external information provision source, the data being generated based on a prompt sentence by the generative artificial intelligence model.

The term “type information of the plurality of external information provision sources” refers to data indicating attributes or categories of external information provision sources, such as service type, protocol type, or domain type, used to characterize how reservation information should be acquired from each source.

The term “explanation generation conditions” refers to parameters or constraints specified in a prompt sentence that direct the generative artificial intelligence model as to how explanation sentences and purchase guidance information should be generated, including which differences or aspects of reservation information to summarize and how to present purchasing possibilities.

In one embodiment, a server includes at least one processor, a main memory, a non-transitory storage device, and a network interface. The server is connected to one or more terminals operated by users via a communication network. The server executes program modules stored in the storage device and loaded into the main memory, such as a web application module, a data acquisition module, a data normalization module, a comparison module, a display generation module, a redirect control module, and an AI interaction module. The server further accesses a generative AI model provided either as a remote service via an application programming interface or as a locally deployed neural network. The terminal includes a processor, a memory, a display unit, an input unit such as a touch panel or keyboard, and a communication interface. The terminal executes a web browser or dedicated application to display user interfaces generated by the server and to transmit user inputs to the server. The user operates the terminal to input identification information of an accommodation target and to select reservation information.

The server executes the web application module on top of an operating system such as a general-purpose server operating system. The web application module may be implemented using a web framework such as a general-purpose web framework executed by an interpreter language runtime. The server provides an input/output screen to the terminal through a browser-compatible interface. The screen contains an input field for the accommodation target identification information, such as a facility name, and an activation control for starting the reservation information retrieval.

The server uses the data acquisition module to obtain reservation information from a plurality of external information provision sources. The server accesses the external information provision sources via the communication network by issuing hypertext transfer protocol requests. The external information provision sources can include reservation platforms, data service endpoints, or other server systems that expose reservation-related data through web pages or application programming interfaces.

The server, when accessing web pages, uses an HTML parsing component implemented with a document parsing library to analyze the returned document object. The server identifies HTML elements containing price information, available time period information, and cancellation condition information based on predetermined selectors or patterns. When the external information provision source renders content with client-side scripts, the server uses a browser automation environment, such as a headless browser controlled via a scriptable interface, to execute client-side code and to obtain a fully rendered document object model before extraction.

The server converts text fragments obtained from the external information provision sources into structured analysis data. The server defines an internal data structure, such as a record or object, including fields such as a facility identifier, a source identifier, a normalized price value, a normalized start time, a normalized end time, a normalized cancellation condition parameter, and a retrieval timestamp. The server maps heterogeneous textual expressions, such as different currency formats, time formats, and natural language cancellation descriptions, into unified numeric or categorical fields. For example, the server transforms a textual price string with currency symbols and delimiters into a numeric price value stored in a fixed unit; the server transforms a time range string into two time values stored in a standardized time zone and format; and the server transforms a natural language cancellation description into a parameter such as a number of days before arrival for free cancellation and a penalty category.

The server stores the analysis data in a structured data repository implemented with a relational database management system or another structured storage engine. The server defines tables or collections corresponding to facilities, external information provision sources, and reservation records, with relational links via identifiers. The server uses indexing on key columns such as facility identifiers, price values, and cancellation parameters to accelerate subsequent queries. This structured storage permits high-throughput retrieval and sorting of reservation information, which improves system response time compared to unstructured or on-the-fly parsing.

The server uses the comparison module to convert the analysis data into comparison data. The comparison module executes ranking and classification operations based on predetermined comparison criteria. The server defines, for example, a primary sort by ascending price value, a secondary sort by descending flexibility of cancellation conditions, and a tertiary sort by earliest available start time. The server may compute derived metrics such as the difference between each price and the minimum price, a categorization of cancellation conditions into classes, or a measurement representing the length of the available time period. The server writes the comparison result into a structured list of items, each item including normalized fields and derived metrics. By defining and applying these criteria at the server side using pre-indexed structures, the server reduces processing overhead at the terminal and reduces total data transfer volume by transmitting only organized comparison data.

The server uses the display generation module to generate screen information representing a list format view for the terminal. The server embeds the comparison data into a templated page structure, where each reservation option is represented as a visual block containing the normalized price, available time period, cancellation condition description, and optional tags such as “lowest price” or “flexible cancellation.” The server associates each visual block with underlying identification information, such as a reservation record identifier or a source identifier, to be used when the user selects an option. The server transmits the generated screen information to the terminal via the communication network.

The terminal renders the received screen information on the display unit. The user observes, on the terminal, a list of reservation options with unified presentation, without needing to interpret heterogeneous formats. The user can compare prices, available time periods, and cancellation conditions directly on one screen. The user then operates the terminal to select one of the reservation options by activating a control associated with that option. The terminal transmits the identification information of the selected reservation information to the server.

The server uses the redirect control module to process the selection. The server reads the identification information of the selected reservation record and retrieves, from the storage device, the connection destination information corresponding to the external information provision source that provides that reservation option. The server generates a redirect instruction and transmits it to the terminal. The terminal then requests the external information provision source at the indicated connection destination, such as a uniform resource locator for a reservation detail page. The user is thus moved from the server's environment to the external information provision source where the purchase process is executed.

In order to provide enhanced decision support and purchase guidance, the server uses the AI interaction module to communicate with a generative AI model. The generative AI model is implemented as a trained neural network, such as a transformer-based sequence model configured for natural language generation, with multiple layers including self-attention layers, feedforward layers, and embedding layers. The model is trained on large-scale text data and fine-tuned on task-specific data that includes examples of explaining reservation conditions, comparing options, and describing purchase steps. The server uses the generative AI model as a computing component that can transform structured comparison data and instructions into natural-language text.

The server constructs prompt sentences that encode both the comparison data and control instructions for the generative AI model. The server maps normalized fields, such as numeric prices and cancellation days, into textual expressions and uses a fixed template that specifies which aspects the model should describe. For example, when generating an explanation sentence, the server may construct a prompt sentence such as:
“You are a system that explains reservation options for an accommodation. Compare the following options for the facility identified by the user. Option A: price 10,000 yen, available time 15:00-22:00, cancellation policy: free cancellation up to 3 days before. Option B: price 9,500 yen, available time 14:00-21:00, cancellation policy: free cancellation until the previous day. In English, describe in one concise paragraph which option is cheaper, how the available times differ, and how the cancellation policies differ, so that a general user can easily understand.”

The server transmits this prompt sentence to the generative AI model via a network interface or internal call, depending on deployment. The generative AI model processes the tokenized prompt using its transformer architecture, where each token is embedded into a vector, passed through multi-head attention operations and nonlinear transformations, and then decoded into an output sequence. During generation, the model uses a probability distribution over vocabulary tokens, updated at each step based on attention to the prompt and previously generated tokens. The model parameters, such as layer weights and attention matrices, are fixed after training, and the inference process deterministically maps input tokens to probability distributions subject to decoding strategies such as greedy decoding or beam search. The server then receives the generated explanation sentence as plain text.

The server integrates the explanation sentence into the screen information. The server attaches the explanation sentence above or near the list format representing the reservation options. The terminal displays the explanation sentence along with the structured list. As a result, the user receives both the normalized, sortable list and a machine-generated explanation that highlights key differences. This combination reduces the cognitive effort required of the user, and, by leveraging pre-normalized structured data in the prompt construction, the system improves the consistency and accuracy of generated explanations. The server also uses the generative AI model to generate purchase guidance information. When the user selects a specific reservation option, the server constructs a second type of prompt sentence that describes the selected option, the corresponding external information provision source, and the purchase context. For example, the server may construct a prompt sentence such as:
“Explain to the user how to complete the purchase for the following reservation option at the external booking site. The selected option has price 9,500 yen, available time 14:00-21:00, and cancellation policy: free cancellation until the previous day. In English, describe step by step what the user will generally need to do on the external site, including confirming the option details, entering personal information, and confirming payment, in a concise and clear paragraph.”

The server transmits this prompt sentence to the generative AI model. The model uses the same underlying transformer architecture to generate the purchase guidance information. The server receives the generated guidance and displays it on the terminal either before redirecting to the external site or in parallel with the redirect. This mechanism allows the user to understand what actions will be required at the external site and what conditions are associated with the selected option, thereby reducing the risk of misunderstanding and abandoned transactions.

From a technical perspective, the server does not simply offload human reasoning to the AI model; instead, the server constrains and structures the input to the AI model using normalized analysis data and comparison data. The server implements strict data transformations and internal representations that serve as an interface between raw heterogeneous reservation information and controlled natural-language generation. By doing so, the server ensures that the AI model operates on standardized parameters rather than arbitrary free-form text, which leads to more predictable and verifiable outputs. This architecture improves the overall reliability of the computer system and allows the generative AI model to be used as a functional component within a deterministic processing pipeline. The server also defines and stores AI configuration parameters, such as temperature, maximum token count, and decoding strategy, and selects these parameters based on the task type (explanation versus purchase guidance). The server may assign lower temperature and constrained output length for purchase guidance to reduce variability, and a slightly higher temperature and richer expressions for comparative explanations. By programmatically controlling these parameters, the server optimizes the balance between fluency and determinism in the generated text, which directly affects the usability and consistency of the system output.

In another embodiment, the generative AI model is fine-tuned using training data that is specifically prepared from historical reservation logs and user interaction logs. The server collects anonymized pairs of structured comparison data and human-written explanations, and uses them as supervised learning samples. The model training uses a loss function such as cross-entropy between predicted token sequences and reference token sequences, and a weight update method such as stochastic gradient descent with adaptive learning rate. The training process updates the internal parameters of the transformer architecture to better map structured reservation parameters to natural-language descriptions. This fine-tuning process, executed on a separate training infrastructure, produces a model that is more directly aligned with the specific reservation comparison and guidance domain, further improving generation accuracy.

The server's data structures and algorithms also yield technical advantages beyond user convenience. By normalizing reservation information at the time of acquisition and storing compact numeric representations, the server reduces repetitive parsing and string operations for subsequent queries. Indexing and precomputed derived metrics allow the server to respond more quickly to user requests for sorted lists, thereby reducing response latency. Because the server transmits only relevant normalized fields and a limited number of derived metrics to the terminal, the system reduces network bandwidth usage compared to transmitting entire raw pages or unfiltered records from external sources. This reduction in data size and processing steps improves both server throughput and terminal performance. The server's integrated use of the generative AI model also reduces redundant human interaction loops. Instead of requiring the user to navigate multiple external pages, extract and compare conditions manually, and then return to the system, the server presents a consolidated view with machine-generated explanations directly in the reservation list interface. This reduces the number of network round trips and page loads initiated by the user, which in turn reduces total communication load and processing overhead across involved systems.

In a further embodiment, the server can vary the comparison criteria and prompt templates according to user preferences or context. The server may store a user profile indicating that the user prioritizes cancellation flexibility over lowest price, or that the user prefers early check-in times. The server then adjusts the weighting of criteria in the comparison module and changes the explanation prompt to emphasize the most relevant factors. This adaptive behavior is implemented through parameterized ranking functions and prompt generation rules, not through generic human-like reasoning. Such control improves the alignment between system behavior and user needs while preserving a clearly defined computational structure.

In yet another embodiment, the server may deploy the generative AI model locally within the same computing environment as the reservation aggregation modules. In this case, the server loads model parameters into dedicated memory and executes the transformer inference on local processing units, such as graphical processing units or specialized accelerators. The server thereby reduces external communication overhead and latency associated with remote model inference. This configuration is particularly beneficial when the system must handle a high volume of simultaneous user requests and maintain low response times for explanation and guidance generation.

The terminal, throughout these embodiments, remains a relatively thin client. The terminal primarily handles user input and display rendering, while the computationally intensive tasks of normalization, comparison, and AI-based text generation are executed on the server. This division of labor enables support for a wide variety of terminals, including low-powered mobile devices, while maintaining high-quality decision support functionalities.

As a result of these configurations, the system achieves technical effects such as improved processing speed through normalized data structures and indexing, enhanced accuracy and consistency in reservation comparison via server-side ranking algorithms, reduced communication load through compact data transmission, and improved usability and reliability via controlled interaction with a generative AI model. The server, by orchestrating deterministic data processing and structured prompt-based AI generation, improves the functioning of the computer system in a manner that goes beyond mere automation of a human mental process.

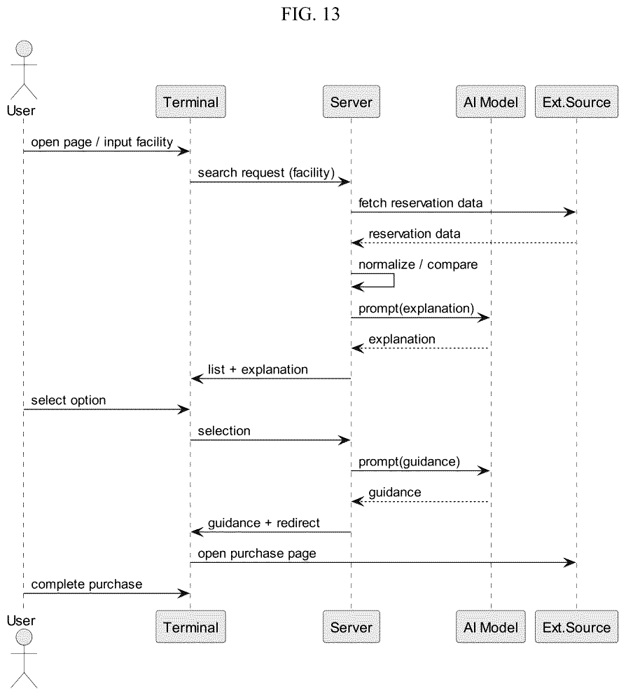

The following describes the processing flow using FIG. 13.

### Step 1:

User operates the terminal to access a reservation aggregation page provided by the server and inputs identification information of an accommodation target, such as a facility name, into an input field displayed on the terminal screen. The input of this step is a text string representing the accommodation target. The terminal converts the user input into a structured request message including at least the text string and a user session identifier, and the terminal transmits the request to the server via a communication network. The output of this step is an HTTP or equivalent network request containing the accommodation target identification information delivered to the server.

### Step 2:

Server receives the request from the terminal through a network interface and extracts the accommodation target identification information from the request parameters. The input of this step is the network request including the text string entered by the user. Server performs validation and sanitization on the text string, such as checking for empty input, truncating excessive length, and escaping special characters, thereby generating a validated identification string. Server records the validated string and metadata such as timestamp and source IP in a log or tracking table. The output of this step is a validated accommodation target identification value stored in server memory and ready for use in data acquisition.

### Step 3:

Server invokes a data acquisition module to obtain reservation information from a plurality of external information provision sources based on the validated identification value. The input of this step is the validated identification information and a configuration of external sources that define access endpoints and query formats. Server constructs source-specific query URLs or request payloads by embedding the identification value into parameter placeholders or body fields. Server transmits these requests via HTTP or an application programming interface to each external source. Server then receives responses, which may include HTML pages or structured data such as JSON or XML. The output of this step is a collection of raw response objects from multiple external information provision sources held in server memory.

### Step 4:

Server parses the raw response objects to extract reservation-related fields. The input of this step is the collection of raw responses from external sources. For responses in HTML, server uses an HTML parsing component to build a document object model and applies selectors or patterns to locate elements containing price texts, time period texts, and cancellation condition texts. For responses requiring client-side execution, server uses a browser automation environment to execute scripts and then obtains a rendered document object model prior to extraction. Server converts each extracted piece into intermediate key-value pairs, such as “price_text,” “time_text,” and “cancellation_text.” The output of this step is a set of intermediate reservation records with textual fields for each external source.

### Step 5:

Server converts the intermediate reservation records into structured analysis data using normalization operations. The input of this step is the set of textual intermediate records. Server applies numeric parsing to “price_text,” removing currency symbols and delimiters and converting the result into an integer or floating-point “price_value.” Server parses “time_text” to derive a standardized start time and end time in a unified format, and server parses “cancellation_text” to derive parameters such as “free_cancellation_days_before” and a category label. Server assembles these normalized fields together with a facility identifier, a source identifier, and a retrieval timestamp into structured records conforming to an internal schema. The output of this step is a list of structured analysis data objects representing reservation options in a uniform, machine-readable format.

### Step 6:

Server stores the structured analysis data in a storage device using a data management engine. The input of this step is the list of normalized analysis data objects. Server prepares insertion or update commands that map each analysis data object to fields in one or more tables or collections, such as a facilities table, a sources table, and a reservations table. Server executes these commands via a database driver and commits the transaction to persist the data. Server may also create or update indices on key fields such as facility identifiers, price values, and cancellation parameters. The output of this step is a persistent dataset of reservations indexed and ready for efficient querying.

### Step 7:

Server queries the stored analysis data to generate comparison data according to predetermined criteria. The input of this step is a facility identifier or equivalent key derived from the validated identification information, and the normalized analysis data stored in the database. Server issues a query selecting all reservation records linked to the accommodation target and then orders or groups them using sorting rules, such as ordering by ascending price_value and then by descending free_cancellation_days_before. Server may compute derived attributes, such as price differences from the minimum price or the duration of the available time period. The output of this step is an ordered list of comparison data entries, each including normalized fields and optional derived metrics.

### Step 8:

Server generates screen information for displaying the comparison data in a list format on the terminal. The input of this step is the ordered list of comparison data entries. Server passes the comparison data into a user interface template, constructing a structured representation such as an HTML document with repeated item blocks, where each block includes labels for price, time period, and cancellation condition, and a selection control associated with an internal reservation identifier. Server may add highlighting for particular attributes, such as marking the lowest price entry. The output of this step is a formatted screen representation that encodes the list of reservation options and is ready to be transmitted to the terminal.

### Step 9:

Terminal receives the screen information from the server and renders it on the display unit for the user. The input of this step is the formatted screen representation transmitted via the communication network. Terminal's browser or client application interprets the structural markup and style information and draws visual list items, text fields, and interactive controls. Terminal maps user-touch or click events to corresponding commands, linking them to underlying reservation identifiers. The output of this step is a visible list of reservation options and an interactive interface that the user can operate.

### Step 10:

User views the displayed list of reservation options on the terminal and evaluates the differences between options, such as differences in price, available time, and cancellation conditions. The input of this step is the visual representation presented by the terminal. User manually compares options and decides which reservation option to select based on the displayed information. User then operates the terminal to activate a selection control associated with a chosen reservation option. The output of this step is a user action associated with a specific reservation identifier.

### Step 11:

Terminal transmits information indicating the selected reservation option to the server. The input of this step is the user action mapped to an internal identifier for the chosen reservation record. Terminal constructs a selection request message that includes the reservation identifier and an associated session context. Terminal sends this message to the server via the communication network. The output of this step is a network request received by the server that specifies which reservation option has been selected.

### Step 12:

Server processes the received selection request to determine a connection destination for redirect and to obtain context for purchase guidance. The input of this step is the selection request containing the reservation identifier. Server queries the stored data to retrieve the reservation record and the external information provision source associated with that record, including a uniform resource locator or equivalent endpoint. Server also collects relevant normalized fields such as price, time period, and cancellation conditions from the selected record to use as context for subsequent guidance generation. The output of this step is a resolved connection destination information object and a selected reservation context set.

### Step 13:

Server constructs a prompt sentence for a generative AI model to create an explanation sentence describing differences among reservation options. The input of this step is the comparison data list and the accommodation target identification information. Server converts key numeric and categorical fields from the comparison data into textual phrases, and concatenates them using a template that describes the explanation task. For example, server may generate a prompt sentence of the form: “You are a system that explains reservation options for an accommodation. Compare the following options for the facility identified by the user. Option A: price 10,000 yen, available time 15:00-22:00, cancellation policy: free cancellation up to 3 days before. Option B: price 9,500 yen, available time 14:00-21:00, cancellation policy: free cancellation until the previous day. In English, describe in one concise paragraph which option is cheaper, how the available times differ, and how the cancellation policies differ, so that a general user can easily understand.” The output of this step is a well-formed prompt sentence that encodes structured comparison data and instructions.

### Step 14:

Server transmits the constructed prompt sentence to the generative AI model and obtains an explanation sentence. The input of this step is the prompt sentence created in the previous step. Server sends the prompt sentence to a neural network-based generative AI model via an application programming interface or internal function call. The model performs an inference computation, applying its trained parameters to transform the prompt into a probability distribution over textual tokens and decoding the most likely sequence according to a decoding strategy. Server receives the generated explanation sentence as plain text. The output of this step is a natural-language explanation sentence describing advantages and disadvantages of the multiple reservation options.

### Step 15:

Server integrates the explanation sentence into updated screen information and transmits it to the terminal. The input of this step is the explanation sentence and the existing comparison data used in the list view. Server updates the template or view model to include a textual area, such as a paragraph above or adjacent to the list, containing the explanation sentence. Server then transmits the updated screen information to the terminal. The output of this step is an enhanced list display definition that includes both structured comparison entries and an AI-generated explanation.

### Step 16:

Terminal renders the updated screen information including the explanation sentence and presents it to the user. The input of this step is the updated screen representation from the server. Terminal re-renders the interface, displaying the explanation sentence in a designated region and the list of reservation options below it. The output of this step is a combined visual display providing both a human-readable explanation and an interactive comparison list.

### Step 17:

Server constructs a second prompt sentence for the generative AI model to generate purchase guidance information for the selected reservation. The input of this step is the context set for the selected reservation option, including normalized price, time period, and cancellation condition, and optionally attributes of the external information provision source. Server converts these context values into descriptive text segments and inserts them into a guidance template. For example, server may generate a prompt sentence such as: “Explain to the user how to complete the purchase for the following reservation option at the external booking site. The selected option has price 9,500 yen, available time 14:00-21:00, and cancellation policy: free cancellation until the previous day. In English, describe step by step what the user will generally need to do on the external site, including confirming the option details, entering personal information, and confirming payment, in a concise and clear paragraph.” The output of this step is a purchase-guidance-oriented prompt sentence.

### Step 18:

Server sends the purchase guidance prompt sentence to the generative AI model and receives purchase guidance information. The input of this step is the purchase guidance prompt sentence. Server forwards this sentence to the generative AI model, which processes it using its internal neural architecture to generate a sequence of tokens describing the steps and considerations involved in completing the purchase. Server receives the resulting purchase guidance information text. The output of this step is a natural-language description of purchase steps tailored to the selected reservation context.

### Step 19:

Server generates a guidance display that includes the purchase guidance information and associates it with the selected reservation option on the terminal. The input of this step is the purchase guidance text and the selected reservation context. Server augments the user interface representation to add a guidance section, which may be shown immediately after selection or immediately before redirecting to the external site. Server transmits this guidance display definition to the terminal. The output of this step is a screen representation that visually links the selected reservation details with explanatory guidance text.

### Step 20:

Server transmits a redirect instruction to the terminal based on the connection destination information corresponding to the selected reservation. The input of this step is the connection destination information resolved earlier. Server generates a response that instructs the terminal to access the external information provision source at the indicated network address.

Server may embed the redirect instruction as an HTTP redirect response or as a link within the guidance display. The output of this step is a redirect directive sent to the terminal.

### Step 21:

Terminal executes the redirect instruction and accesses the external information provision source to enable the user to complete the purchase. The input of this step is the redirect directive or link provided by the server. Terminal initiates a new network request to the external information provision source at the specified address and renders the received reservation or purchase page. The output of this step is a new display showing the external site's interface, where the user can follow the previously presented guidance to confirm the reservation details, enter personal information, and finalize the payment.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional reservation aggregation systems typically rely on fixed query templates and static comparison logic implemented in application code. Such systems require developers to hard-code search parameters, data parsing rules, and comparison criteria for each external data source. As a result, when new information sources are added, when the data schema of an existing source is changed, or when comparison criteria must be adapted to a particular user's context, the server logic must be manually modified and redeployed. This leads to significant maintenance overhead, reduced scalability, and degraded robustness in a heterogeneous data environment.

Furthermore, known systems usually perform only simple, rule-based sorting and filtering of reservation information. They do not leverage dynamically generated, semantic analyses such as text-level advantages and disadvantages per option, and they do not integrate emotion-aware re-ranking based on a user's real-time emotional state. As a consequence, these systems provide limited assistance to the user when comparing options and selecting a reservation, and they are unable to adapt the presentation logic to the user's cognitive and emotional conditions.

In addition, in conventional architectures, request construction toward external reservation providers and settlement systems is primarily encoded as static API clients or redirect URL templates. When reservation conditions or purchase flows differ between providers, the server must implement provider-specific client code, increasing complexity and limiting extensibility. There is no general mechanism for using a generative AI model to synthesize search conditions, communication parameters, and purchase request configurations from higher-level semantic descriptions.

From the viewpoint of computer technology, these limitations manifest as rigid and brittle server-side workflows, poor abstraction of cross-provider protocols, and insufficient utilization of machine-generated instructions to dynamically orchestrate information retrieval, comparison, and transaction processes. Therefore, there is a need for an improved computer-implemented system that can: (i) dynamically generate prompt sentences for a generative AI model to control search, analysis, and purchase workflows; (ii) automatically structure heterogeneous reservation information into comparison-ready list data; (iii) integrate emotion estimation to algorithmically adjust ranking and emphasis of results; and (iv) generate provider-agnostic purchase communication requests, thereby improving flexibility, maintainability, and performance of the overall information processing pipeline.

The specific processing by the specific processing unit 290 of the data processing device 12 in Application Example 2 is realized by the following means.

The present invention provides a server comprising a processor configured to receive, from an information terminal, input data representing a facility-identifying name, to generate, based on the facility-identifying name, one or more prompt sentences for a generative AI model, to cause the generative AI model to output search-related information in response to the prompt sentences, to acquire, based on the search-related information, reservation-related information concerning the facility from a plurality of storage resources, and to convert the reservation-related information into structured list data suitable for display and machine processing; the processor further configured to analyze attribute information included in the reservation-related information, to generate additional prompt sentences for the generative AI model so as to obtain analysis information representing advantages and disadvantages of each reservation-related information item, to associate the analysis information with the corresponding reservation-related information items so as to form comparison data, and to transmit presentation information including the structured list data and the comparison data to the information terminal; the processor further configured to acquire emotion-related information corresponding to a user, to estimate an emotional state of the user by using an emotion estimation model based on the emotion-related information, to generate control information for changing at least one of a display order and an emphasis degree of the reservation-related information according to the emotional state, to reconstruct the structured list data based on the control information, to receive, from the information terminal, a selection of one reservation-related information item, and, based on the selected reservation-related information item, to generate prompt sentences for the generative AI model that describe a purchase operation, to obtain, from the generative AI model, configuration information of a communication request for a settlement processing system, and to generate and transmit the communication request to the settlement processing system based on the configuration information. This enables the server to dynamically orchestrate multi-source reservation retrieval, semantic comparison, emotion-aware ranking, and provider-agnostic purchase transactions by using generative AI model outputs as machine-readable instructions, thereby improving the flexibility, maintainability, and technical performance of the computer-based reservation processing architecture.

The term “system” refers to a combination of hardware resources and software resources, including at least one information processing apparatus configured to execute the processes defined in the claims.

The term “processor” refers to one or more hardware-based information processing units, such as a central processing unit, a graphics processing unit, or a dedicated logic circuit, configured to execute instructions that implement the claimed functions.

The term “information terminal” refers to an electronic apparatus operated by a user, such as a portable communication device, a desktop computing device, or a display-equipped control device, which is capable of transmitting input data to, and receiving output data from, the system.

The term “user” refers to a human operator or an organization that interacts with the information terminal to request, review, and select reservation-related information.

The term “facility-identifying name” refers to a character string or symbol sequence input by the user to distinguish a particular service-providing place, service provider, or utilization location from other entities.

The term “generative AI model” refers to a machine-learned information processing model, such as a neural network-based language model, configured to generate output data including text or structured data in response to input data including prompt sentences.

The term “prompt sentence” refers to a text expression or structured instruction supplied to a generative AI model in order to specify a task, a context, or a constraint, and to cause the generative AI model to generate a corresponding output.

The term “search-related information” refers to information output by the generative AI model that describes search conditions, query parameters, or control instructions used to obtain reservation-related information from storage resources.

The term “storage resource” refers to an information storage environment, such as a database system, a file storage system, or a network-accessible information service, that stores reservation-related information or data required to obtain reservation-related information. The term “reservation-related information” refers to data describing a reservable option for the facility, including at least date and time information, price information, cancellation-condition information, evaluation information, or identifiers for external providers.

The term “structured list data” refers to reservation-related information that has been organized into a machine-readable data structure, such as a table, an array, or a set of records, suitable for ordered display and algorithmic processing.

The term “attribute information” refers to individual data elements associated with reservation-related information, including at least price information, time information, cancellation-condition information, evaluation information, or other descriptive parameters. The term “advantages and disadvantages” refers to evaluation aspects or qualitative features of each reservation-related information item, expressed as positive factors and negative factors relative to at least one criterion such as cost, flexibility, or user convenience. The term “analysis information” refers to data output by the generative AI model that represents, in text or structured form, the advantages and disadvantages or other comparative characteristics of reservation-related information items.

The term “comparison data” refers to a data structure in which analysis information is associated with respective reservation-related information items so as to enable comparative evaluation among a plurality of reservation-related information items.

The term “presentation information” refers to data transmitted from the system to the information terminal, including at least structured list data and comparison data, which is formatted or format-ready for rendering on a user interface.

The term “selection operation” refers to an input action by the user, captured by the information terminal, that indicates a choice of one reservation-related information item from among a plurality of reservation-related information items.

The term “settlement processing system” refers to an external or internal transaction-processing environment, such as a payment gateway or reservation-confirmation server, that is configured to receive purchase-related communication requests and to perform payment or booking confirmation.

The term “communication request” refers to a data message, such as a network request, generated and transmitted from the processor to the settlement processing system in order to execute or confirm a purchase corresponding to a selected reservation-related information item.

The term “emotion-related information” refers to data indicative of a user's emotional state, including at least one of expression information derived from image data, voice information derived from audio data, and character information derived from text data.

The term “emotion estimation model” refers to a machine-learned model configured to receive emotion-related information and to output an estimated emotional state, such as joy, stress, or neutrality, possibly with an intensity level.

The term “emotional state” refers to an inferred psychological condition of the user, such as pleasure, displeasure, tension, relaxation, or neutrality, determined based on emotion-related information by the emotion estimation model.

The term “control information” refers to data generated by the processor that specifies how to modify at least one of a display order, a selection priority, or an emphasis degree of reservation-related information in accordance with the emotional state.

The term “display order” refers to a sequence in which reservation-related information items are arranged and presented to the user on the information terminal.

The term “emphasis degree” refers to a level or style of visual or interactional prominence applied to reservation-related information, such as highlighting, labeling, or grouping, to draw the user's attention to certain items.

The term “recommendation data” refers to data that includes a calculated priority or ranking for each reservation-related information item, derived from evaluation information or analysis information, and used to recommend certain items over others.

The term “evaluation information” refers to numerical or categorical data representing a degree of suitability or recommendation of a reservation-related information item, such as rating scores, recommendation degrees, or preference indicators.

The term “configuration information of a communication request” refers to parameters, endpoint identifiers, payload structures, or protocol settings required to construct a communication request for the settlement processing system.

The term “purchase process” refers to a sequence of operations performed by the settlement processing system, initiated by a communication request, for confirming a reservation and, when applicable, processing financial settlement.

In one embodiment, a server executes a reservation processing program on a hardware platform that includes at least one central processing unit, a volatile memory, a non-volatile storage device, and a network interface controller. The server runs an operating system such as a general-purpose server operating system, and a web application framework such as a Python-based framework. The server exposes network-accessible interfaces using Hypertext Transfer Protocol over Transport Layer Security.

A terminal comprises a client device such as a smartphone, tablet, notebook computer, or desktop computer. The terminal includes at least a display, a pointing or touch input device, a microphone, a camera, a memory, and a communication module. The terminal executes a browser application or a native application that communicates with the server over a packet-switched network.

A user operates the terminal to input a facility-identifying name. The user enters a textual string representing, for example, a category of restaurant, a lodging facility, or a leisure service. The terminal converts the user's keystrokes or touch operations into a Unicode string and stores the string in a local data structure. The terminal then transmits the string to the server encoded as part of an application-layer message such as a request message body.

The server receives the facility-identifying name and stores it into a request-handling context in memory. The server generates at least one prompt sentence for a generative AI model. The prompt sentence is a natural-language instruction string that encodes, in a single sequence, a description of the facility-identifying name, constraints for search conditions, and formatting requirements for a machine-readable response. For example, the server generates prompt sentences including the following text:
“Using the facility name ‘Italian restaurant’, propose multiple search keyword combinations and query parameter sets for retrieving reservation information from several reservation databases.”
“Here is a list of reservation options with price, time, and cancellation policy. Compare their advantages and disadvantages for a user who values low price and flexible cancellation.”
“The user appears stressed. From the following reservation options, select three options that are most suitable for relaxation, and explain why.”

The server transmits the prompt sentence and associated context data to a generative AI model. In one embodiment, the generative AI model is executed by a remote model-hosting system and is accessed by the server via a model access interface. The generative AI model is implemented as a deep neural network language model that includes a token embedding layer, a plurality of transformer blocks, and an output projection layer. Each transformer block includes a multi-head self-attention module, a feed-forward neural sub-network, and layer normalization. The generative AI model has parameter matrices that have been trained using gradient descent on large-scale text corpora.

The server tokenizes the prompt sentence into token identifiers according to a subword vocabulary and transmits the identifiers to the generative AI model. The server receives from the generative AI model a sequence of output tokens that represent generated text. The server decodes the token sequence into a character string and stores the result in memory. The server then parses the generated text using deterministic text-processing procedures. For example, the server extracts search keywords, filter values such as price ranges and time ranges, source identifiers for storage resources, and ranking scores recommended by the model. The server converts these elements into structured data such as key-value mappings in memory. Because the parsing rules are aligned with the prompt format, the server can reliably map generated text into well-defined program parameters, improving robustness compared to free-form natural language responses.

The server uses the structured data to construct search requests for a plurality of storage resources. A storage resource may be a remote application programming interface endpoint, a web content server, or an internal database instance. The server uses networking libraries to generate application-layer requests that include query parameters and headers according to the structured data extracted from the generative AI model response. The server transmits multiple requests in parallel. In one variant, the server uses asynchronous event-driven programming to dispatch parallel non-blocking requests, thereby reducing wall-clock latency for aggregating reservation-related information.

The server receives responses from the storage resources and stores raw response data in memory buffers. When the response is a hypertext document, the server uses an HTML parsing library to construct a document object tree and traverses the tree to locate nodes containing reservation-related information. When the response is a structured data document such as a markup or lightweight data-interchange format, the server decodes the response into native data structures such as objects and lists.

The server extracts reservation-related information from the parsed structures. The reservation-related information includes attributes such as price, available start time, end time, cancellation conditions, ratings, and source identifiers. The server normalizes units (for example, converting various currency displays into normalized numeric values) and converts time formats into a standard representation. The server then stores each reservation item as a record in an in-memory collection and, in one embodiment, as a record in a relational data table managed by a database engine. The table schema includes columns for the facility-identifying name, temporal information, monetary information, cancellation conditions, rating values, external URLs, and metadata returned from the generative AI model such as recommendation degrees.

The server also uses the generative AI model to obtain analysis information that describes advantages and disadvantages for each reservation-related information item. The server constructs another prompt sentence that embeds a subset of the reservation-related information as textual content. For example, the server generates a prompt sentence including the following text:
“Here is a list of reservation options with facility name, price, time window, and cancellation policy. For each option, output short bullet points describing its main advantages and main disadvantages.”

The server transmits the prompt sentence together with a serialized representation of the reservation-related information to the generative AI model and receives generated text. The server parses the generated text to separate advantage descriptions and disadvantage descriptions and associates these descriptions with respective reservation records. The server stores the analysis information in additional fields in the same database table or in a related table that references the reservation records via keys.

The server generates structured list data that combines the raw reservation-related information and the analysis information. The structured list data is organized as an ordered collection of entries, where each entry includes normalized numeric attributes, textual descriptions, and a reference to an external provider. The server transmits this list data to the terminal. The terminal converts the list data into a user interface representation, displaying each entry with the facility name, price, time, cancellation conditions, rating, and textual advantages and disadvantages. The user can visually compare multiple entries.

The server acquires emotion-related information to further refine the list presentation. The terminal uses its camera to capture images of the user's face at discrete moments or continuously while the user interacts with the display. The terminal optionally uses its microphone to record audio segments of the user's speech. The terminal transmits these media items to the server. The server pre-processes the image data using an image-processing library. The server detects a facial region using a convolutional neural network-based face detector and extracts facial feature maps. The server then applies an emotion estimation model implemented as a deep convolutional neural network or a hybrid convolutional-recurrent network. The emotion estimation model outputs a probability distribution over a fixed set of emotional states such as joy, stress, and neutral. The server selects an emotional state by choosing the label with the highest probability and may also retain the probability vector as confidence values.

When audio data is provided, the server applies a speech-to-features pipeline. The server computes spectrograms or mel-frequency cepstral coefficients from the audio samples and feeds the features into an acoustic neural network classifier that outputs emotional state probabilities. The server can fuse visual and acoustic probabilities by weighted averaging or by using a late-fusion classifier. In some embodiments, these emotion models are trained using supervised learning with labeled emotion datasets, optimizing cross-entropy loss with stochastic gradient descent or a variant. The training process updates network weights to minimize classification error on emotion labels. By combining visual and acoustic signals, the server increases the robustness and accuracy of emotion state estimation compared to relying on a single modality.

The server generates control information that indicates how to modify the list data based on the estimated emotional state. For example, when the state indicates stress, the server increases ranking scores for reservation items associated with relaxing or quiet facilities and decreases scores for noisy or crowded facilities. The server computes updated ranking scores by applying weighting coefficients to existing ranking attributes derived from the generative AI model and from ratings. When the state indicates joy, the server increases ranking scores for highly rated or celebratory facilities. The server modifies emphasis degrees in the list data by setting flags that instruct the terminal to highlight certain items or display “recommended” labels.

The server reconstructs the structured list data based on the control information. The server sorts records according to updated ranking scores using an efficient sorting algorithm and updates emphasis flags and grouping attributes. The server transmits the updated list to the terminal. The terminal updates the display so that items most relevant to the user's emotional state appear at higher positions and with stronger visual emphasis. This emotion-adaptive re-ranking is not limited to heuristic thresholds; rather, it is driven by the combined outputs of trained neural models and the computed weighting scheme, providing a technical mechanism that adapts content ordering in real time based on sensor-derived user state.

The user views the emotion-aware list and selects one reservation-related information item on the terminal. The terminal detects a selection event and sends an identifier of the selected record to the server. The server retrieves the corresponding record from the database and prepares to initiate a purchase transaction. To construct a communication request for a settlement processing system, the server can either use preconfigured templates or utilize the generative AI model to synthesize request configuration information.

In one embodiment, the server constructs a prompt sentence describing the selected reservation record and the abstract purchase objective, such as:
“Given the following selected reservation record with facility, time, price, and provider identifier, construct the necessary parameters and endpoint path for issuing a booking confirmation request to the provider's settlement system.”

The server transmits the prompt sentence and the serialized reservation record to the generative AI model and receives a generated description of the communication request configuration, including parameter names, parameter values, and an endpoint path pattern. The server validates the generated configuration by checking syntactic conformance to whitelists and parameter schemas stored locally. After validation, the server constructs the actual communication request and transmits it to the settlement processing system via the network. The settlement processing system returns a confirmation response containing a reservation identifier and possibly a payment authorization token. The server stores these values in the database and constructs output data that the terminal can display as a confirmation screen.

By offloading the synthesis of query structures, comparison narratives, and request configurations to the generative AI model and by enforcing deterministic parsing and validation in the server, the system improves computer technology in several specific ways. First, the server reduces the amount of static, provider-specific client code that must be implemented and maintained, because the server can dynamically generate and adapt request parameters when providers change their interfaces. Second, the server improves processing efficiency by using the generative AI model to produce compact, semantically rich analyses that guide ranking and filtering, thereby reducing downstream computation needed to achieve similar decision quality with purely rule-based methods. Third, the server improves data management by storing normalized attributes and model-derived annotations in a structured schema, enabling efficient indexing and query execution by the database engine.

The server's use of neural network-based emotion estimation adds additional technical advantages. By processing multi-modal sensor data using trained models, the server can infer user state without requiring explicit user input. This reduces the number of manual settings and interactions and allows the server to automatically adjust ranking and emphasis in near real time. The emotion estimation models are trained with explicit loss functions, and their parameters are stored and used to compute high-dimensional feature transformations that would be impractical to perform manually. Thus, the server implements a technical pipeline for signal acquisition, feature extraction, classification, and personalization at the data structure level.

The server employs specific non-conventional control logic that combines outputs from the generative AI model and the emotion estimation model. For example, the server can compute a composite ranking score as a linear or non-linear function of: a recommendation degree score produced by the generative AI model, a normalized price score, a rating score, and an emotion-specific weight vector. The server then uses this composite score to drive both sorting and emphasis control. Such combined scoring reduces error in recommending inappropriate options and improves convergence of presented options toward the user's latent preferences, resulting in more accurate content delivery with fewer user interactions.

In some embodiments, the server executes alternative configurations. The server may run a generative AI model locally instead of via a remote provider, using dedicated accelerators such as graphics processing units or tensor processing units to accelerate token generation. The server may employ different neural architectures for the generative AI model, such as encoder-decoder transformer networks or recurrent networks with attention, trained with maximum-likelihood objectives or reinforcement learning-based fine-tuning. The server may implement different database backends, such as document stores, graph databases, or in-memory key-value stores, provided that they can store and retrieve reservation-related information and associated analysis fields.

The terminal may also vary in implementation. In one embodiment, the terminal runs a native application that pre-processes media data to extract embeddings using local neural network models before sending low-dimensional feature vectors to the server, thereby reducing communication load and protecting user privacy. In another embodiment, the terminal performs a portion of the user interface logic, such as local sorting or filtering based on precomputed scores received from the server.

The user interacts with the system primarily through graphical widgets rendered on the terminal. The user may, for example, modify preferences or constraints, and the server can incorporate these inputs into additional prompt sentences so that the generative AI model refines search conditions or comparison criteria. For instance, the server may generate a prompt sentence:
“Given that the user prefers low price and free cancellation, re-evaluate the following reservation options and output updated recommendation scores.”

By encoding such contextual preferences as text in the prompt sentence and integrating them into the model's attention-based processing, the system can adapt search and comparison behavior without requiring reprogramming of application logic. This improves the extensibility and maintainability of the software architecture and demonstrates that the use of the generative AI model yields a technical improvement over conventional hard-coded comparison logic.

Across these embodiments, the server, the terminal, and the user cooperate through defined data structures, neural network models, and deterministic control logic to implement a reservation handling architecture that dynamically generates, analyzes, and adjusts reservation-related information. The architecture leverages specific model structures, training methods, and data flows to provide technical effects including but not limited to reduced latency in multi-source aggregation, improved accuracy of rankings and recommendations, reduced maintenance of client code for external systems, and efficient utilization of communication and computation resources.

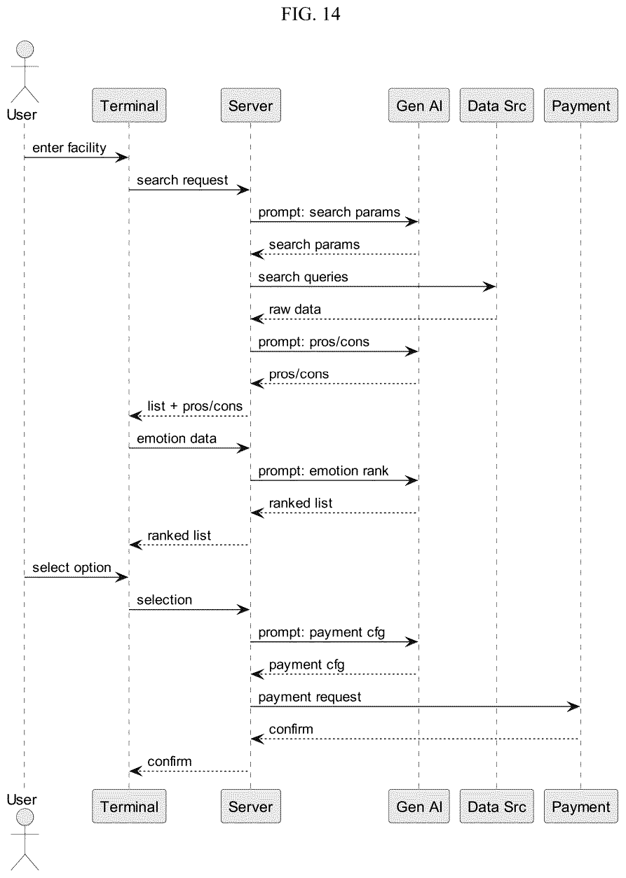

The following describes the processing flow using FIG. 14.

### Step 1:

User operates the terminal and inputs a facility-identifying name such as “Italian restaurant” into an input field displayed on the terminal.
Input: User's keystrokes or touch operations.
Output: A Unicode text string representing the facility-identifying name stored in the terminal's memory.

Terminal converts the input operations into a character string, associates the string with a request object, and prepares the data for transmission to the server.

### Step 2:

Terminal transmits the facility-identifying name to the server using a network request.
Input: The Unicode text string representing the facility-identifying name.
Output: An application-layer message (for example, an HTTPS POST request) containing the facility-identifying name as payload data.

Terminal encapsulates the string in a protocol-specific format such as JSON or form data, adds required headers, and sends the message over a network interface to the server.

### Step 3:

Server receives the request and stores the facility-identifying name in a request-handling context.
Input: The application-layer message from the terminal containing the facility-identifying name.
Output: An internal data structure in server memory holding the facility-identifying name and metadata (timestamp, session ID).

Server parses the incoming message, extracts the facility-identifying name, and allocates memory to create a structured object that will be used throughout subsequent processing.

### Step 4:

Server generates a first prompt sentence for a generative AI model to derive search conditions.
Input: The facility-identifying name stored in the request-handling context.
Output: A prompt sentence string describing the search task, including the facility-identifying name and required output format.

Server concatenates template text and the facility-identifying name, forming instructions such as “Using the facility name ‘Italian restaurant’, propose multiple search keyword combinations and query parameter sets for retrieving reservation information from several reservation databases.” The server stores this prompt sentence in memory.

### Step 5:

Server sends the prompt sentence to the generative AI model and receives generated search-related information.
Input: The prompt sentence generated in Step 4.
Output: A generated text sequence representing search-related information, including suggested keywords, filters, and source identifiers.

Server tokenizes the prompt sentence according to the model's vocabulary, transmits the token sequence to the model via a model access interface, receives output tokens from the model, decodes them into text, and stores the resulting text string as model output.

### Step 6:

Server parses the generated search-related information and converts it into structured parameters for multiple storage resources.
Input: The generated text sequence from the generative AI model.
Output: Structured search parameters such as keyword lists, price ranges, time ranges, and source-specific query parameters stored in internal data structures.

Server applies deterministic parsing rules: it scans the text for delimiter patterns, splits the text into segments for each resource, extracts tokens representing parameter names and values, casts numeric strings to numeric types, and constructs key-value mappings for each external storage resource.

### Step 7:

Server constructs and transmits search requests to a plurality of storage resources based on the structured parameters.
Input: The structured search parameters associated with each storage resource.
Output: Multiple outbound network requests, each targeting a different storage resource with specific query parameters.

Server maps each parameter set to a corresponding endpoint URL, encodes parameters into query strings or request bodies, sets headers, and dispatches the requests asynchronously using non-blocking I/O or thread-based concurrency to optimize latency.

### Step 8:

Server receives responses from the storage resources and buffers the raw data.
Input: Network responses from the storage resources (HTML documents or structured data responses).
Output: A collection of raw response payloads stored in memory buffers, each associated with its source identifier.

Server listens for completion events or response callbacks, retrieves each response body, tags it with the corresponding resource ID, and saves it in a response collection for further processing.

### Step 9:

Server parses the raw response data to extract reservation-related information.
Input: The collection of raw response payloads (HTML or structured data formats).
Output: A list of reservation-related information records, each containing attributes such as time, price, cancellation conditions, and ratings.

Server applies different parsing mechanisms depending on content type: for HTML, the server builds a document tree and traverses nodes with specific tags or classes; for structured data, the server deserializes the content into objects. The server then copies relevant fields into normalized record structures, performing type conversion and unit normalization.

### Step 10:

Server normalizes and aggregates the extracted reservation-related information.
Input: The list of raw reservation-related records extracted in Step 9.
Output: A unified in-memory collection of standardized reservation records with consistent attribute formats.

Server iterates over each record, converts all time values to a common time representation, converts all prices to a single numeric format, maps source-specific field names to canonical attribute names, and appends the normalized records to a central collection.

### Step 11:

Server stores the normalized reservation-related information in a database and prepares for efficient retrieval.
Input: The unified in-memory collection of reservation records.
Output: Persistent database records in a reservation table indexed by facility-identifying name, time, and price.

Server connects to a database engine, composes insert or update operations for each record, executes these operations, and commits the transactions. The server also updates or creates indices to support fast search and sorting by relevant fields such as price, start time, or rating.

### Step 12:

Server generates a second prompt sentence for the generative AI model to analyze advantages and disadvantages of each reservation option.
Input: A selected subset of reservation-related information from the database or in-memory collection.
Output: A prompt sentence embedding reservation details and requesting pros and cons analysis for each option.

Server serializes essential attributes (facility name, price, time window, cancellation conditions) into a text block, inserts this block into a template instruction such as “Here is a list of reservation options with facility name, price, time window, and cancellation policy. For each option, output short bullet points describing its main advantages and main disadvantages.” and stores the resulting prompt sentence.

### Step 13:

Server sends the second prompt sentence to the generative AI model and receives analysis information.
Input: The second prompt sentence containing serialized reservation details.
Output: Generated text containing advantages and disadvantages for each reservation option.

Server tokenizes the prompt, transmits the tokens, receives output tokens from the generative AI model, decodes them to text, and associates the generated analysis text with the corresponding reservation options using markers embedded in the prompt.

### Step 14:

Server parses and attaches the analysis information to individual reservation records.
Input: The generated analysis text from the generative AI model.
Output: Updated reservation records that include structured fields for advantages and disadvantages.

Server splits the analysis text into sections per reservation item using predefined delimiters, separates advantage text from disadvantage text, trims extraneous formatting, and stores these strings in new fields of each reservation record, either in memory or in the database.

### Step 15:

Server composes structured list data combining raw attributes and analysis fields for presentation.
Input: The updated reservation records with attributes and attached analysis information.
Output: An ordered collection of presentation entries where each entry contains normalized attributes and associated pros and cons.

Server selects relevant fields from each record, organizes them into a list or array, determines an initial ordering (for example, by price or rating), and builds a serializable data structure ready for transmission to the terminal.

### Step 16:

Server transmits the structured list data to the terminal for initial display.
Input: The presentation-ready list data constructed in Step 15.
Output: An application-layer response containing the list data formatted as a structured payload that the terminal can render.

Server encodes the list data into a response format, attaches necessary headers, and sends the response back to the terminal, which receives the data and prepares the user interface.

### Step 17:

Terminal renders the list and allows user interaction for comparison.
Input: The structured list data received from the server.
Output: A graphical user interface showing reservation options with their attributes and pros and cons, along with selectable controls.

Terminal parses the structured data, generates visual components for each entry, displays facility name, price, times, cancellation policy, rating, advantages, and disadvantages, and presents selection buttons or touch targets that the user can operate.

### Step 18:

Terminal captures emotion-related sensor data while the user is viewing the list.
Input: The current visual context of the displayed list and user presence in front of the terminal.
Output: Image frames from the camera and, optionally, audio segments from the microphone stored as media samples.

Terminal activates the camera to capture facial images at configured intervals and activates the microphone to record audio snippets, buffering the media data and preparing it for transmission to the server.

### Step 19:

Terminal transmits the emotion-related media data to the server.
Input: Buffered image frames and audio segments captured in Step 18.
Output: Network messages containing encoded media data associated with the current user session.

Terminal compresses images and audio to suitable formats, attaches session identifiers, and sends the media data to the server via secure network requests.

### Step 20:

Server processes the media data and estimates the user's emotional state.
Input: The image frames and audio segments received from the terminal.
Output: An estimated emotional state label and associated confidence values.

Server applies image pre-processing to detect faces, extracts facial features with a convolutional neural network, computes feature vectors, and passes them through an emotion classification layer. If audio is present, the server computes spectral features, feeds them into an acoustic classifier, and combines the visual and acoustic outputs. The server then selects an emotion label such as “joy” or “stress” based on maximum probability and stores this emotional state for use in ranking.

### Step 21:

Server generates control information for re-ranking and emphasizing reservation-related information based on the emotional state.
Input: The estimated emotional state and the current reservation records with attributes and analysis information.
Output: Control information specifying updated ranking scores and emphasis flags for each reservation record.

Server computes a composite score for each record as a function of recommendation degree, price, rating, and an emotion-specific weight vector. For example, for a stressed state, the server increases weights for relaxing facilities. The server also sets emphasis flags indicating which records should be highlighted or marked as recommended.

### Step 22:

Server reconstructs the structured list data according to the control information and transmits the updated list to the terminal.
Input: The control information with updated scores and flags, and the existing reservation records.
Output: A re-ordered and revised list data structure emphasizing items suited to the user's emotional state.

Server sorts the records by updated scores, applies grouping or labeling based on emphasis flags, rebuilds the list data in the new order, encodes it into a response, and sends the updated list to the terminal.

### Step 23:

Terminal updates the display to show the emotion-adapted reservation list.
Input: The updated list data received from the server.
Output: A refreshed user interface where high-priority items for the current emotional state appear prominently.

Terminal re-renders the entries according to the new order, applies visual emphasis (such as highlighting or badges) to marked items, and provides the user with an updated comparison view.

### Step 24:

User selects a reservation option on the terminal.
Input: The displayed reservation list and interactive controls.
Output: A user selection event identifying a particular reservation record.

User taps or clicks on a “Select” or “Book” control associated with a chosen entry. Terminal detects the event, reads the associated record identifier, and prepares a selection message.

### Step 25:

Terminal transmits the selection information to the server.
Input: The record identifier and any additional selection parameters (such as number of participants or specific date).
Output: A network request containing the selected reservation-related information reference.

Terminal encodes the selection into an application-layer message and sends it to the server over the network connection.

### Step 26:

Server retrieves the selected reservation record and generates a purchase-configuration prompt sentence for the generative AI model.
Input: The record identifier received from the terminal and the corresponding reservation record from the database.
Output: A prompt sentence describing the selected reservation and requesting configuration information for a communication request to a settlement processing system.

Server queries the database for the selected record, serializes necessary attributes (facility, time, price, provider ID), and embeds them into a template instruction such as “Given the following selected reservation record with facility, time, price, and provider identifier, construct the necessary parameters and endpoint path for issuing a booking confirmation request to the provider's settlement system.”

### Step 27:

Server sends the purchase-configuration prompt sentence to the generative AI model and receives configuration information.
Input: The purchase-configuration prompt sentence and serialized reservation attributes.
Output: Generated text describing endpoint paths, parameter names, and parameter values for a booking request.

Server tokenizes the prompt, sends tokens to the generative AI model, receives generated tokens, decodes them, and stores the resulting configuration text for further interpretation.

### Step 28:

Server parses the generated configuration information and constructs a communication request to the settlement processing system.
Input: The configuration text produced by the generative AI model and local schemas defining valid request structures.
Output: A fully formed communication request object ready to be transmitted to the settlement processing system.

Server extracts endpoint URLs, parameter key-value pairs, and method type from the configuration text, validates them against whitelists and expected formats, converts them into a concrete request object, and binds authentication credentials if required.

### Step 29:

Server transmits the communication request to the settlement processing system and receives a purchase confirmation response.
Input: The constructed communication request.
Output: A confirmation response containing a reservation identifier, payment authorization, or error information.

Server sends the request using a secure network channel, waits for the response, reads the response payload, and decodes it into structured fields such as confirmation code and status.

### Step 30:

Server stores the confirmation information and sends a final confirmation message to the terminal.
Input: The confirmation response from the settlement processing system and the selected reservation record.
Output: A confirmation message containing details of the completed reservation, ready for display to the user.

Server inserts the confirmation code and related data into the database, associates it with the user session, constructs a final response including facility name, date and time, price, and confirmation code, and transmits this response to the terminal.

### Step 31:

Terminal displays the confirmation details to the user.
Input: The final confirmation message from the server.
Output: A confirmation screen indicating successful reservation, including key details and any follow-up instructions.

Terminal parses the message, populates a confirmation view with the reservation information and confirmation code, and presents the view on the display so that the user can verify that the reservation has been successfully completed.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

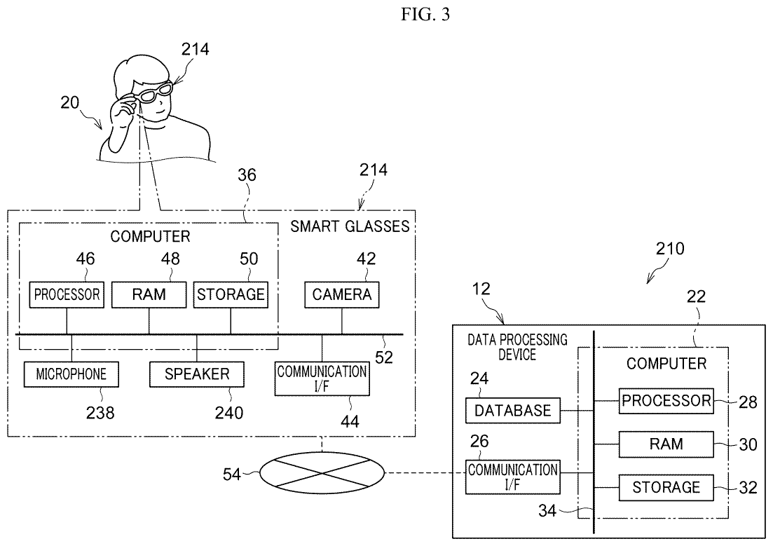

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

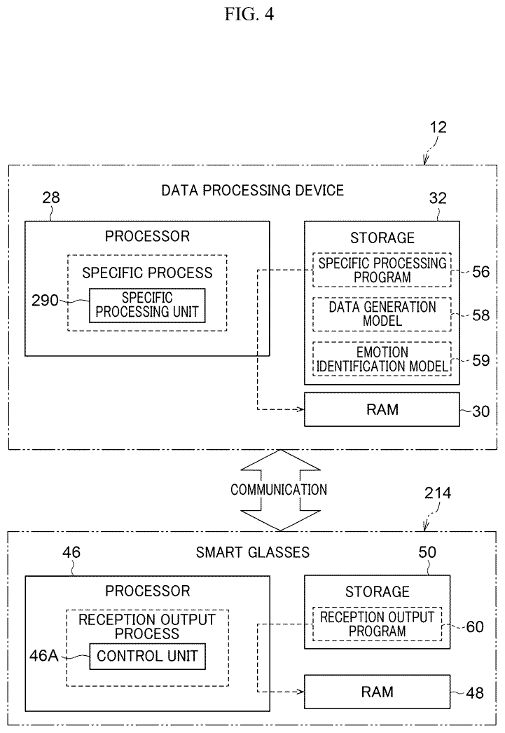

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

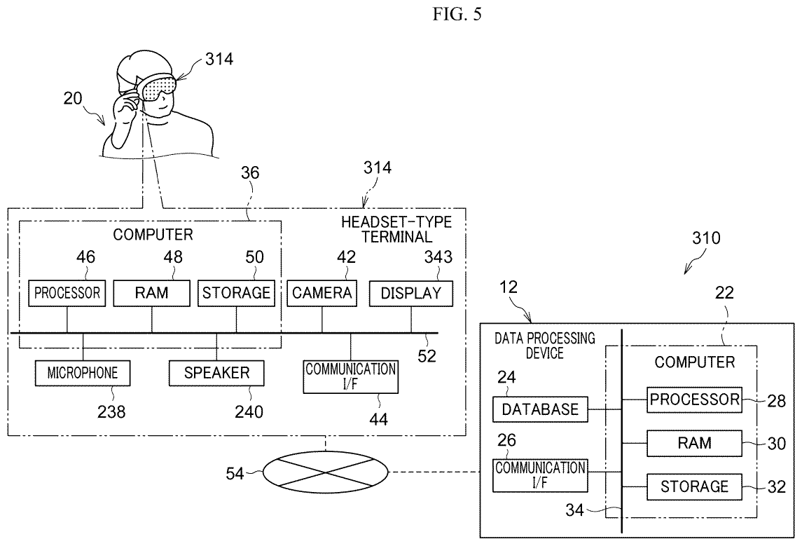

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

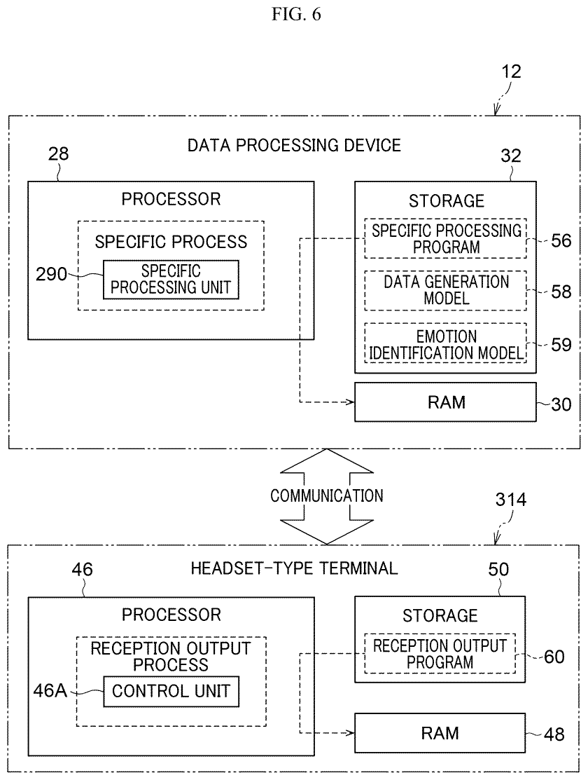

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

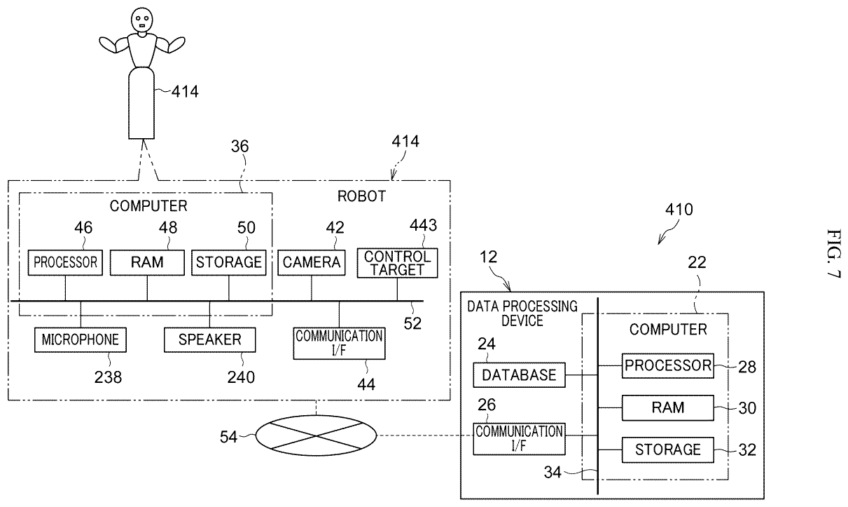

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

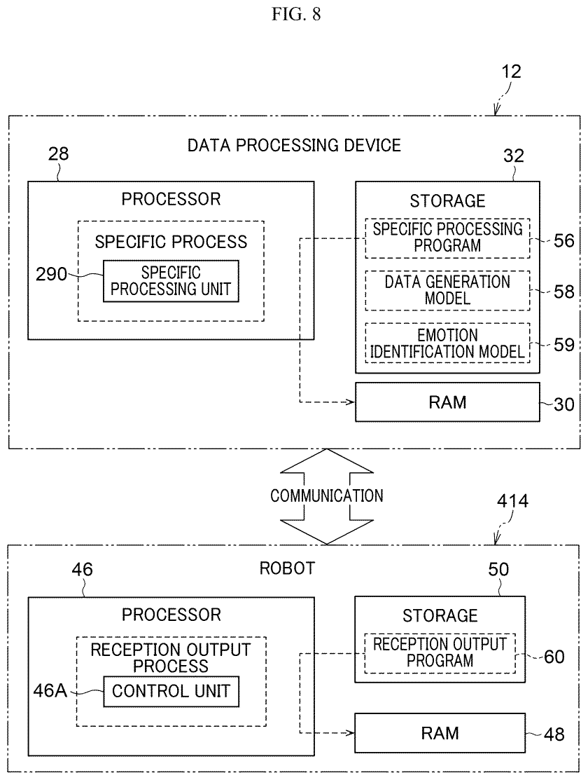

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

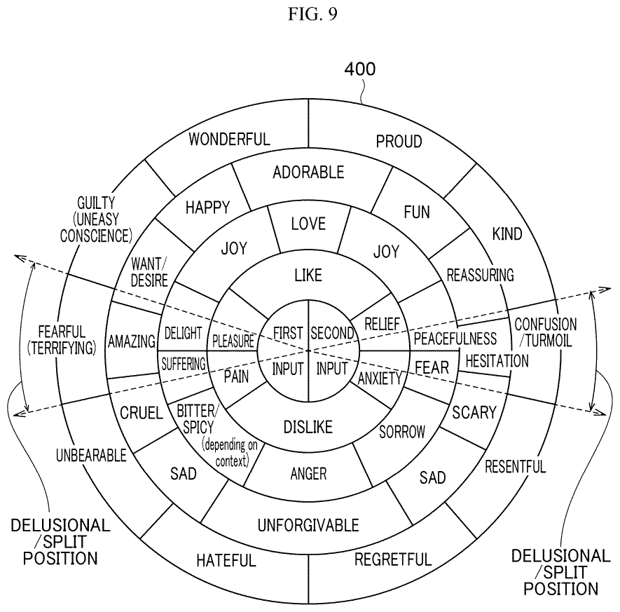

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

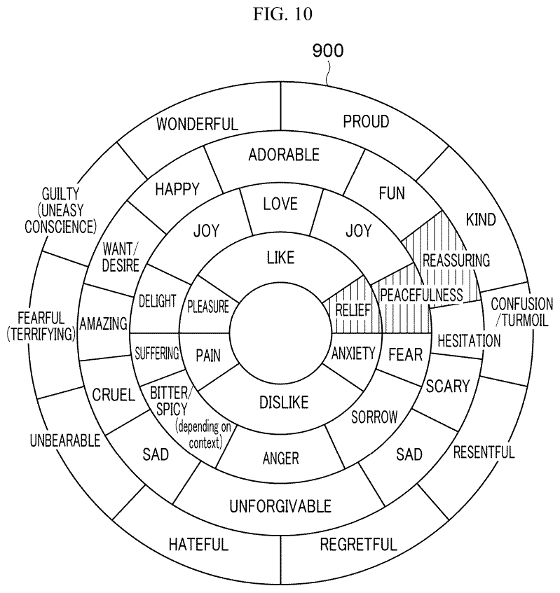

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
receive, from a user terminal via a communication interface, search conditions including a name for specifying a facility to be used, and generate a prompt sentence for a generative AI model in accordance with the search conditions, and transmit a request including the prompt sentence to the generative AI model,
execute, in a general-purpose program execution environment, a scraping program independently of a response from the generative AI model, acquire reservation information from a plurality of information sources based on the search conditions, normalize the reservation information by attribute including at least a price, an available time period, and a cancellation condition, store the normalized reservation information, and generate display information for listing the reservation information to the user terminal based on the stored reservation information,
generate, using attribute data of the stored reservation information, a comparison prompt sentence for the generative AI model, transmit a request including the comparison prompt sentence to the generative AI model, acquire an analysis result indicating advantages and disadvantages for each piece of the reservation information from the generative AI model, and process the analysis result into a format associated with the list display and presentable to the user terminal,
receive, from the user terminal, selection information indicating that one of a plurality of pieces of reservation information included in the list display has been selected, identify, based on the selection information, connection destination identification information of an information source corresponding to the selected reservation information from the stored reservation information, and generate control information for guiding the user terminal to an external site based on the connection destination identification information, and
cause the generative AI model to generate a purchase instruction prompt sentence indicating that a purchase process based on the selected reservation information is to be executed at the external site, acquire response data based on the purchase instruction prompt sentence, and present, to the user terminal, guidance information regarding the purchase process based on the response data.

### Supplementary 2

The system according to supplementary 1,
wherein the processor is configured to
cause the generative AI model to generate an acquisition instruction prompt sentence including attribute data of the reservation information acquired by the scraping program as input data, acquire, from the generative AI model based on the acquisition instruction prompt sentence, complementary reservation information, integrate the complementary reservation information into the stored reservation information, and use the integrated reservation information for the list display and the analysis of the advantages and disadvantages.

### Supplementary 3

The system according to supplementary 1,
wherein the processor is configured to
cause the generative AI model to generate a purchase guidance prompt sentence including the connection destination identification information corresponding to the selection information and the attribute data of the reservation information, acquire response data from the generative AI model based on the purchase guidance prompt sentence, and perform guidance control for guiding the user terminal to a screen on the information source where a purchase can be performed directly, in accordance with the response data.

### Application Example 1

### Supplementary 1

A system comprising a processor,
wherein the processor is configured to
acquire, via an information processing terminal, a designation of a facility input by a user, generate search instruction information including the designation of the facility, and transmit, on the basis of the search instruction information, communication requests to response programs of a plurality of information providing sources so as to acquire reservation information relating to the facility,
normalize the reservation information acquired from the plurality of information providing sources into a common attribute format including price information, available time information, cancellation condition information, and identification information of the information providing source, and integrate the normalized reservation information into a data structure for comparison,
store the integrated reservation information in a storage device, acquire, from the storage device, a group of reservation information corresponding to the designation of the facility, and generate comparison display information by performing at least sorting or extraction on the group of reservation information on the basis of at least the price information and the available time information,
transmit the comparison display information to the information processing terminal so as to cause the information processing terminal to visually display the reservation information in a list format and to receive from the information processing terminal a selection operation by the user for particular reservation information,
generate guidance information for guiding the user to a reservation confirmation screen on a provider side outside the system that corresponds to the selected reservation information, and transmit the guidance information to the information processing terminal so as to guide the user to a reservation confirmation process on the provider side,
generate a prompt sentence for a generative learning model, the prompt sentence including at least one of the comparison display information and the group of reservation information, cause the generative learning model to analyze advantages and disadvantages of the reservation information on the basis of the prompt sentence, acquire an analysis result from the generative learning model, and generate explanation information to be presented to the user on the basis of the analysis result, and
generate, for the generative learning model, a prompt sentence based on the reservation information selected by the user, the prompt sentence instructing execution of a transaction, and generate, on the basis of the prompt sentence, control information that instructs execution of a transaction process on the provider side outside the system.

### Supplementary 2

The system according to supplementary 1,
wherein the processor is configured to generate, for the generative learning model, a prompt sentence including the designation of the facility and acquisition conditions relating to the plurality of information providing sources, generate acquisition control information that instructs acquisition of reservation information from the plurality of information providing sources on the basis of the prompt sentence, and acquire the reservation information from the plurality of information providing sources on the basis of the acquisition control information.

### Supplementary 3

The system according to supplementary 1,
wherein the processor is configured to generate, for the generative learning model, a prompt sentence including identification information of an external provider associated with the reservation information selected by the user and content indicating that a direct transaction is possible at the external provider, cause the generative learning model to generate transaction control information instructing the direct transaction at the external provider on the basis of the prompt sentence, and guide the user to a transaction process of the external provider on the basis of the transaction control information.

### Example 2

### Supplementary 1

A system comprising a processor,
wherein the processor is configured to
receive, from an information processing terminal, identification information of an accommodation target input by a user via an input/output screen of the information processing terminal; and
execute, based on the identification information, an information acquisition process to obtain reservation information related to the accommodation target from a plurality of external information provision sources via a communication network, analyze the obtained reservation information to convert the reservation information into structured analysis data, and store the analysis data in a storage device; and
normalize price information, available time period information, and cancellation condition information included in the analysis data, and generate comparison data by classifying or ranking the reservation information according to predetermined comparison criteria; and generate screen information for causing the reservation information to be displayed in a list format on the information processing terminal based on the comparison data, and transmit the screen information to the information processing terminal to cause the list format to be displayed; and
obtain connection destination information of an external information provision source associated with selected reservation information based on identification information of the selected reservation information among a plurality of pieces of reservation information displayed in the list format, the identification information being received from the information processing terminal, and cause the information processing terminal to be redirected to the connection destination information; and
transmit, to a generative artificial intelligence model, a prompt sentence including the comparison data and the identification information of the accommodation target, and cause the generative artificial intelligence model to generate an explanation sentence describing advantages and disadvantages of the plurality of pieces of reservation information, and output the generated explanation sentence to the information processing terminal in association with the display in the list format; and
transmit, to the generative artificial intelligence model, a prompt sentence instructing execution of a purchase process based on the selected reservation information, and cause the generative artificial intelligence model to generate purchase guidance information describing contents of the purchase process at the external information provision source, and output the generated purchase guidance information to the information processing terminal.

### Supplementary 2

The system according to supplementary 1,
wherein the processor is configured to
cause the obtaining of the reservation information from the plurality of external information provision sources to include transmitting, to the generative artificial intelligence model, a prompt sentence including the identification information of the accommodation target and type information of the plurality of external information provision sources, causing the generative artificial intelligence model to generate acquisition instruction information indicating acquisition conditions and acquisition destinations of the reservation information to be obtained from each of the external information provision sources, and executing the information acquisition process based on the generated acquisition instruction information.

### Supplementary 3

The system according to supplementary 1,
wherein the processor is configured to
cause the prompt sentence transmitted to the generative artificial intelligence model to specify explanation generation conditions including presenting, to the user, summarized differences in price, differences in available time periods, and differences in cancellation conditions among the respective pieces of reservation information included in the comparison data, and presenting that a direct purchase is possible at the external information provision source corresponding to the selected reservation information, and cause the generative artificial intelligence model to generate the explanation sentence and the purchase guidance information based on the explanation generation conditions.

### Application Example 2

### Supplementary 1

A system comprising a processor,
wherein the processor is configured to
receive, from an information terminal operated by a user, input data representing a name that identifies a facility, generate a prompt sentence for a generative AI model based on the name that identifies the facility, cause the generative AI model to output search-related information in response to the prompt sentence, acquire, based on the search-related information,
reservation-related information concerning the facility from a plurality of storage resources, and convert the reservation-related information into structured list data for display,
analyze attribute information included in the reservation-related information, the attribute information comprising at least price information, time information, cancellation-condition information, and evaluation information, generate a prompt sentence for the generative AI model so as to cause the generative AI model to output analysis information representing advantages and disadvantages of each reservation-related information item, obtain the analysis information from the generative AI model in response to the prompt sentence, and generate comparison data by associating the analysis information with each reservation-related information item,
transmit presentation information including the structured list data and the comparison data to the information terminal, receive, from the information terminal, a selection operation performed by the user that selects one of the reservation-related information items, and, based on the selected reservation-related information item, generate a prompt sentence that instructs execution of a purchase process by a settlement processing system, and control a communication process with the settlement processing system based on the prompt sentence, acquire emotion-related information including at least one of expression information, voice information, and character information relating to the user, estimate an emotional state of the user by using an emotion estimation model based on the emotion-related information, generate control information for changing at least one of a display order and an emphasis degree of the reservation-related information according to the emotional state, and reconstruct the structured list data based on the control information.

### Supplementary 2

The system according to supplementary 1,
wherein the processor is configured to
input, to the generative AI model, a data structure including the name that identifies the facility and reservation-related information accumulated in the past, obtain, from the generative AI model, response information including search conditions for the plurality of storage resources, communication-request parameters, and evaluation information representing a recommendation degree of each reservation-related information item, and generate recommendation data by calculating a priority of each reservation-related information item based on the evaluation information.

### Supplementary 3

The system according to supplementary 1,
wherein the processor is configured to
input, to the generative AI model, a data structure including a reservation-related information item selected by the user and connection-destination information of the settlement processing system, obtain, from the generative AI model, response information including configuration information of a communication request for confirming a purchase of the selected reservation-related information item, and generate and transmit the communication request to the settlement processing system based on the configuration information.

What is claimed is:

1. A system comprising:
circuitry configured to
receive, via a packet-switched network, an input data set from a terminal device, the input data set comprising an entity identifier specifying a target for which structured record data is to be retrieved,
generate, based on the entity identifier, a first structured input sequence for a generative neural network model, the first structured input sequence instructing the generative neural network model to produce retrieval parameters for obtaining the structured record data from a plurality of external data endpoints,
execute a data acquisition process that transmits query requests to the plurality of external data endpoints based on the retrieval parameters, receives response data from the plurality of external data endpoints, and normalizes the response data into attribute-categorized data records stored in a data repository,
generate, from attribute fields of the attribute-categorized data records, a second structured input sequence for the generative neural network model, the second structured input sequence instructing the generative neural network model to produce a comparative analysis output evaluating the attribute-categorized data records, and
transmit, via the packet-switched network, the comparative analysis output together with the attribute-categorized data records to the terminal device for rendering on a display of the terminal device.

2. The system according to claim 1, wherein the circuitry is further configured to:
receive, via the packet-switched network, a selection signal from the terminal device indicating a selected data record from among the attribute-categorized data records, and
generate, based on the selected data record, a third structured input sequence for the generative neural network model, the third structured input sequence instructing the generative neural network model to produce transaction execution parameters for completing a processing operation associated with the selected data record.

3. The system according to claim 2, wherein the circuitry is further configured to:
identify, from the selected data record, a connection destination identifier corresponding to an external data endpoint from which the selected data record was acquired, and generate control information for directing the terminal device to an interface provided by the external data endpoint based on the connection destination identifier.

4. The system according to claim 3, wherein the transaction execution parameters comprise a transaction guidance instruction, and wherein the circuitry is further configured to:
transmit the transaction guidance instruction to the generative neural network model,
acquire response data from the generative neural network model based on the transaction guidance instruction, and
transmit, to the terminal device, guidance data derived from the response data for rendering in association with the interface of the external data endpoint.

5. The system according to claim 4, wherein the external data endpoint is a reservation service website, the selected data record comprises reservation availability data including a price attribute, a time period attribute, and a cancellation condition attribute, and the guidance data comprises step-by-step purchase instructions generated by the generative neural network model.

6. The system according to claim 1, wherein the data acquisition process comprises:
executing, in a program execution environment of the circuitry, an automated retrieval module that transmits HTTP requests to the plurality of external data endpoints independently of a response from the generative neural network model, and
parsing HTML or structured response data returned by the plurality of external data endpoints to extract the structured record data.

7. The system according to claim 6, wherein the circuitry is further configured to:
normalize the extracted structured record data by mapping heterogeneous attribute labels from different external data endpoints to a unified attribute schema comprising a set of predefined attribute categories.

8. The system according to claim 7, wherein the predefined attribute categories comprise at least a cost attribute, a temporal availability attribute, and a policy condition attribute, and wherein the circuitry stores the normalized data records in indexed form in the data repository.

9. The system according to claim 1, wherein the comparative analysis output comprises, for each attribute-categorized data record, a respective advantage indicator and a respective disadvantage indicator generated by the generative neural network model based on relative comparison of the attribute fields across the attribute-categorized data records.

10. The system according to claim 9, wherein the circuitry is further configured to:
associate each respective advantage indicator and each respective disadvantage indicator with a corresponding data record identifier, and
generate a ranked list of the attribute-categorized data records based on an aggregation of the advantage indicators and the disadvantage indicators.

11. The system according to claim 1, wherein the first structured input sequence encodes the entity identifier and a natural language instruction segment within a prompt template retrieved from a storage device, and wherein the generative neural network model is a transformer-based language model comprising a plurality of self-attention layers.

12. The system according to claim 11, wherein the circuitry is further configured to:
append to the first structured input sequence a user-supplied natural language query received from the terminal device, and
cause the generative neural network model to incorporate the user-supplied natural language query when generating the retrieval parameters.

13. The system according to claim 1, wherein the circuitry is further configured to:
generate an enrichment structured input sequence comprising the attribute-categorized data records as input data for the generative neural network model,
acquire, from the generative neural network model, complementary attribute data not present in the response data from the plurality of external data endpoints, and
integrate the complementary attribute data into the attribute-categorized data records stored in the data repository.

14. The system according to claim 13, wherein the complementary attribute data comprises at least one of user review summary data, geographic proximity data, or accessibility condition data generated by the generative neural network model from training knowledge.

15. The system according to claim 1, wherein the circuitry is further configured to:
apply an affective state classifier to a text input received from the terminal device to determine an affective state label of a user,
record a temporal change of the affective state label across successive interactions, and
modify the second structured input sequence to include the affective state label, thereby causing the generative neural network model to adjust a tone of the comparative analysis output based on the affective state label.

16. The system according to claim 1, wherein the circuitry is further configured to:
receive, via the packet-switched network, image frame data from an image acquisition interface of the terminal device,
apply a convolutional neural network-based expression classification model to the image frame data to determine an expression label indicating an emotional state of a user, and
incorporate the expression label into the second structured input sequence for the generative neural network model.

17. The system according to claim 1, wherein the circuitry is further configured to:
store, in the data repository, a history record comprising the entity identifier, the attribute-categorized data records, the comparative analysis output, and user interaction data, and
compute, from a plurality of stored history records, updated prompt template parameters for generating subsequent structured input sequences.

18. A system comprising:
circuitry configured to
receive, via a packet-switched network, an entity identifier from a terminal device,
generate a first structured input sequence for a generative neural network model based on the entity identifier,
execute a data acquisition process to retrieve structured record data from a plurality of external data endpoints and normalize the structured record data into attribute-categorized data records,
generate a second structured input sequence from the attribute-categorized data records for the generative neural network model to produce a comparative analysis output,
transmit the comparative analysis output to the terminal device for rendering on a display,
receive a selection signal indicating a selected data record,
generate a third structured input sequence instructing the generative neural network model to produce transaction execution parameters associated with the selected data record, and
transmit, via the packet-switched network, the transaction execution parameters to the terminal device.

19. The system according to claim 18, wherein the circuitry is further configured to:
identify a connection destination identifier from the selected data record, and
generate control information for directing the terminal device to an interface provided by an external data endpoint corresponding to the connection destination identifier, the transaction execution parameters comprising guidance data for completing a processing operation at the external data endpoint.

20. A method performed by a system comprising circuitry, the method comprising:
receiving, via a packet-switched network, an input data set from a terminal device, the input data set comprising an entity identifier specifying a target for which structured record data is to be retrieved;
generating, based on the entity identifier, a first structured input sequence for a generative neural network model, the first structured input sequence instructing the generative neural network model to produce retrieval parameters for obtaining the structured record data from a plurality of external data endpoints;
executing a data acquisition process that transmits query requests to the plurality of external data endpoints based on the retrieval parameters, receives response data from the plurality of external data endpoints, and normalizes the response data into attribute-categorized data records stored in a data repository;
generating, from attribute fields of the attribute-categorized data records, a second structured input sequence for the generative neural network model, the second structured input sequence instructing the generative neural network model to produce a comparative analysis output evaluating the attribute-categorized data records; and
transmitting, via the packet-switched network, the comparative analysis output together with the attribute-categorized data records to the terminal device for rendering on a display of the terminal device.
